(19) United States
(12) Patent Application Publication
(10) Pub. No.: US 2016/0102168 A1
(43) Pub. Date: Apr. 14, 2016

(54) BIO-BASED DIISOCYANATE AND CHAIN EXTENDERS IN CRYSTALLINE SEGMENTED THERMOPLASTIC POLYESTER URETHANES

(71) Applicant: Trent University, Peterborough (CA)

(72) Inventors: Suresh Narine, Peterborough (CA); Shaojun Li, Peterborough (CA); Jesmy Jose, Peterborough (CA); Laziz Bouzidi, Peterborough (CA)

(73) Assignee: TRENT UNIVERSITY, Peterborough (CA)

(21) Appl. No.: 14/854,810

(22) Filed: Sep. 15, 2015

Related U.S. Application Data
(60) Provisional application No. 62/051,821, filed on Sep. 17, 2014.

(51) Int. Cl. C08G 18/73; C08G 18/32

(52) U.S. Cl. CPC C08G 18/73; C08G 18/3221

(57) ABSTRACT

The synthesis of semi-crystalline thermoplastic polyester urethanes is disclosed. The synthesis describes parameters such as controlled concentration, distribution, and types of crystalline hard segment blocks to correlate the effect of hard segment crystallinity to that of the soft segment blocks.

### CROSS REFERENCE TO RELATED APPLICATIONS

A claim of priority for this application under 35 U.S.C. §119(e) is hereby made to U.S. Provisional Patent Application No. 62/051,821 filed Sep. 17, 2014; and this application is incorporated herein by reference in its entirety.

### TECHNICAL FIELD

This application relates to semi-crystalline thermoplastic polyester urethanes with controlled concentration, distribution, and types of crystalline hard segment blocks to correlate the effect of hard segment crystallinity to that of the soft segment blocks.

### BACKGROUND

Growing concerns over the environmental impacts of non-biodegradable plastic waste and the need for sustainability have stimulated research efforts on biodegradable polymers from renewable resources. Rising costs and dwindling petrochemical feedstocks also make renewable resource-based materials attractive alternatives to their petroleum-based counterparts.

Segmented thermoplastic polyester urethane (TPEU) elastomers have attracted significant interest because they generate a wide variety of industrial applications ranging from foams and coatings to medical devices, where the hydrolytically labile polyester functions provide controlled degradation. TPEUs may possess the structure (—X—Y—)ₙ, composed of a polyester macro diol, soft segment (SS) block, and urethane rich, hard segment (HS) block. Their versatility stems from the chemical compositions of X and Y units. In conventional TPEU elastomers, the incompatible X and Y units phase separate into nano scale domains of amorphous HS that serve as the load bearing phase in the rubbery soft polyester phase which imparts extensibility.

Research interest on crystalline SS and HS block TPEUs has seen a surge recently, especially due to their potential shape memory properties. Crystallinity of SS-block is observed for sufficiently long macro diols. A moderate soft segment crystallinity in TPEUs leads to increased incompatibility between the hard and soft domains, and enhanced the mechanical performance. Accordingly, numerous studies to tune the ordering of soft segment blocks have been undertaken. This includes varying the type of soft segment, their size, content, introducing side chain liquid crystal soft segments, etc. A systematic conceptual understanding of the role of crystalline HS-blocks in controlling the SS-block crystallinity, however, is limited since the majority of commercial TPEUs do not exhibit hard segment crystallinity. The lack of molecular symmetry for the industrially available diisocyanate molecules and the low molecular weight of chain extenders limited the crystallization of hard segments in commercial TPEUs. However, aliphatic hexamethylene diisocyanate (HMDI) have been shown to offer enhanced ordering of the hard segment and to prevent the hydrolytic degradation of ester groups in poly(ester urethane) elastomers.

TPEUs synthesized from renewable resources have been receiving increased attention due to a perceived need to reduce petroleum dependence and address negative impacts on the environment. A significant amount of that attention has focused on the use of vegetable oil derived feedstock, due to their relative availability, flexibility with regards to chemical modification, low toxicity and inherent biodegradability. Numerous studies have been carried out to develop diols or polyols suitable for polyurethane production from vegetable oils, to entirely or partially replace conventional petroleum-based materials, with a certain degree of success realized. Efforts to synthesize di-isocyanates from vegetable oils have been limited compared to those focused on polyols, but some progress has been made. These have included: (i) synthesis of fatty acid based di-isocyanates; (ii) C36 fatty acid based diisocyanates; and (iii) soybean oil based polyisocyanate prepared via a vinyl bromination of triglycerides followed by substitution with AgNCO. More recently, di-isocyanates were prepared at the lab scale from fatty acid derived diamines using a phosgene method, or directly from fatty acids using Curtius rearrangement. Thermoplastic polyurethanes have been prepared from these fatty acid derived di-isocyanates by combination with either petroleum-based or bio-based diols. However, the resulting materials displayed low molecular weights due to the low chemical reactivity of fatty acid based diisocyanates, particularly 1,7-heptamethylene diisocyanate (HPMDI), produced from Curtius rearrangement of fatty diacids.

The poor performance of HPMDI based thermoplastics have motivated the current effort, which focuses on the optimization of the polymerization reaction conditions, and selection of suitable polyester macro diol and chain extenders in order to develop high molecular weight semi-crystalline TPEU elastomers with varying chemical compositions of the HS and SS-blocks. A series of TPEUs were prepared from a vegetable-oil based di-isocyanate, chain extenders and a petroleum-based polyester macro diol, using varying polymerization protocols. The TPEUs were chemically and physically characterized. The effects of HS-block content, distribution and type on thermal stability, melting and crystallization behavior and mechanical properties were investigated.

### BRIEF DESCRIPTION OF THE DRAWINGS

FIG. 1A depicts a 1H-NMR spectra of pure HS-block TPEU (PU1-100x-0y₀/z₀-9).

FIG. 1B depicts a ¹H-NMR spectra of pure SS-block TPEU (PU2-0x₀-92y₀/z₇₄).

FIG. 1C depicts a ¹H-NMR spectra of PU5-46x₀₋₂-49y₁/z₁-9.

FIG. 1D depicts a ¹H-NMR spectra of N-butyl amine end capped (CₘI)_{y} hard segment (m=9).

FIG. 2 depicts variation of M_{w} (Δ, ▴) (kg/mol) and PDI (◯,) for TPEUs as a function of act 2 reaction time during poly addition by method 3 (closed symbols) and method 4 (open symbols).

FIG. 3 depicts DSC second heating thermograms for TPEUs of S1 series. (1) PU1-100x-0y₀/z₀-9 (2) PU3-74x₅-24y₀/z₁-9 (3) PU3-56x₄-40y₀/z₁-9 (4) PU3-46x₃-49y₀/z₁-9 (5) PU3-36x₂-58y₀/z₁-9 (6) PU3-16x₁-76y₀/z₁-9 (7) PU4-3x₁-88y₀/z₃-9 (8) PU2-0x₀-92y₀/z₇₄ and (9) pure PEAD.

FIG. 4 depicts

$$\frac{1}{{T}_{m 1}}$$

versus

$$\frac{1}{x}$$

for S1 series TPEUs having HS-blocks of different lengths (x=1-5). The line is a linear fit (R²>0.9801).

FIG. 5A depicts WAXD patterns of (1) PU1-100x-0y₀/z₀-9, (2) PU2-0x₀-92y₀/z₇₄ (3) PU4-46x₀₋₃-49y₀/z₁-9, and (4) PU3-46x₃-49y₀/z₁-9 TPEUs measured at room temperature.

FIG. 5B depicts crystalline contribution to the WAXD profiles obtained after subtracting the background and amorphous halo. The indexed reflection planes corresponding to different crystalline forms are represented by the following abbreviations: O, orthorhombic; M, monoclinic; T, triclinic.

FIG. 6 depicts variation of HS-block (closed symbols) and PEAD soft segment (open symbols) melting temperatures (Tₘ₁& Tₘ₂) with the methylene chain length of the chain extender Cm (m=3 (PD), 4(BD), 6, (HD), and 9(ND)) for S3 series of TPEUs.

FIG. 7 depicts a stress-strain curve for 51 and S2 series of TPEUs. (1) For PU3-74x₅-24y₀/z₁-9, (2) PU3-56x₄-40y₀/z₁-9, (3) PU3-46x₃-49y₀/z₁-9, (4) PU4-46x_{0- 3}-49y₀/z₁-9, (5) PU3-16x₁-76y₀/z₁-9, and (6) PU4-16x₀₋₂-76y₀/z₁-9.

FIG. 8 depicts tensile strength (TS), % elongation at break (EB) and initial modulus for S1 series TPEUs with varying HS-block content. The lines are linear fits ((R²>0.9901).

FIG. 9 depicts tensile strength (TS), % elongation at break (EB) and initial modulus for S3 series TPEUs with varying Cₘ values.

FIG. 10 depicts DTG traces of (1) PU1-100x-0y₀/z₀-9 (2) PU3-74x₅-24y₀/z₁-9 (3) PU3-56x₄-40y₀/z₁-9 (4) PU3-46x₃-49y₀/z₁-9 (5) PU3-36x₂-58y₀/z₁-9 (6) PU3-16x₁-76y₀/z₁-9 (7) PU4-3x₁-88y₀/z₃-9 (8) PU2-0x₀-92y₀/z₇₄ and (9) pure PEAD obtained with heating rate of 10° C./min.

FIG. 11 depicts onset degradation temperature, T_{d(onset)} (◯), main peak degradation temperature T_{d(main)} (□), and peak temperature, T_{d3}, due to minor weight loss event for (Δ) for TPEUs belonging to S1 series. The line is a linear fit (R²>9842).

FIG. 12 depicts a schematic representation of [CₘI]ₓ-[P(CₘI)_{y}]_{z} TPEUs. For a fixed polyester diol (P) chain length (2000 g/mol) TPEUs with varying combinations of HS-block type (m), content (x, y) and distribution (x) of HS-blocks were investigated.

### DETAILED DESCRIPTION

The synthesis of certain thermoplastic polyester urethanes having crystallizable hard segments and soft segments were prepared from the following materials: (i) a natural oil based organic isocyanate, (ii) a diol component, and (iii) and a chain extender.

As used herein, the term “natural oil” may refer to oil derived from plants or animal sources. The term “natural oil” includes natural oil derivatives, unless otherwise indicated. Examples of natural oils include, but are not limited to, vegetable oils, algae oils, animal fats, tall oils, derivatives of these oils, combinations of any of these oils, and the like. Representative non-limiting examples of vegetable oils include canola oil, rapeseed oil, coconut oil, corn oil, cottonseed oil, jojoba oil, olive oil, palm oil, peanut oil, safflower oil, sesame oil, soybean oil, sunflower oil, linseed oil, palm kernel oil, tung oil, jatropha oil, mustard oil, camelina oil, pennycress oil, hemp oil, algal oil, and castor oil. Representative non-limiting examples of animal fats include lard, tallow, poultry fat, yellow grease, and fish oil. Tall oils are by-products of wood pulp manufacture. In certain embodiments, the natural oil may be refined, bleached, and/or deodorized. In some embodiments, the natural oil may be partially or fully hydrogenated. In some embodiments, the natural oil is present individually or as mixtures thereof.

Natural oils may include triglycerides of saturated and unsaturated fatty acids. Suitable fatty acids may be saturated or unsaturated (monounsaturated or polyunsaturated) fatty acids, and may have carbon chain lengths of 3 to 36 carbon atoms. Such saturated or unsaturated fatty acids may be aliphatic, aromatic, saturated, unsaturated, straight chain or branched, substituted or unsubstituted, fatty acids, and mono-, di-, tri-, and/or poly-acid variants, hydroxy-substituted variants, aliphatic, cyclic, alicyclic, aromatic, branched, aliphatic- and alicyclic-substituted aromatic, aromatic-substituted aliphatic and alicyclic groups, and heteroatom substituted variants thereof. Any unsaturation may be present at any suitable isomer position along the carbon chain to a person skilled in the art.

The natural oil based organic isocyanate compounds for TPEUs are di-functional isocyanates. The natural oil based organic isocyanates of the described herein have a formula R(NCO)ₙ, where n is 1 to 10, and at times equal to 2, and wherein R includes 2 and 40 carbon atoms, and wherein R contains at least one aliphatic, cyclic, alicyclic, aromatic, branched, aliphatic- and alicyclic-substituted aromatic, aromatic-substituted aliphatic and alicyclic group. Examples of such isocyanates include, but are not limited to, diphenylmethane-4,4′-diisocyanate (MDI), which may either be crude or distilled; toluene-2,4-diisocyanate (TDI); toluene-2,6-diisocyanate (TDI); methylene bis (4-cyclohexylisocyanate (H₁₂MDI); 3-isocyanatomethyl-3,5,5-trimethyl-cyclohexylisocyanate (IPDI); 1,6-hexane diisocyanate (HDI); naphthalene-1,5-diisocyanate (NDI); 1,3- and 1,4-phenylenediisocyanate; polyphenylpolymethylenepolyisocyanate (PMDI); m-xylene diisocyanate (XDI); 1,4-cyclohexyl diisocyanate (CHDI); isophorone diisocyanate; 1,7-heptamethylene diisocyanate (HPMDI); isomers and mixtures or combinations thereof. At times, the natural oil based isocyanate is 1,7-heptamethylene diisocyanate (HPMDI).

The diol component used in the TPEUs are polyester diols. The diols may include hydroxyl-terminated reaction products of dihydric alcohols such as ethylene glycol, propylene glycol, diethylene glycol, neopentyl glycol, 1,4-butanediol, furan dimethanol, cyclohexane dimethanol or polyether diols, or mixtures thereof, with aliphatic dicarboxylic acids (e.g., having 4 to 16 carbon atoms) or their ester-forming derivatives, for example succinic, glutaric and adipic acids or their methyl esters, phthalic anhydride or dimethyl terephthalate. At times, the polyester diol is poly(ethylene adipate) diol, poly(ethylene succinate) diol, poly(ethylene sebacate) diol, poly(butylene adipate) diol, and also at times, poly(ethylene adipate) diol (PEAD).

The chain extenders used in the TPEUs are low-molecular weight compounds containing at least two moieties selected from hydroxyl groups, primary amino groups, secondary amino groups, and other active hydrogen-containing groups reactive with an isocyanate group. Chain extenders include, for example, polyhydric alcohols (especially trihydric alcohols, such as glycerol and trimethylolpropane), polyamines, and combinations thereof. Non-limiting examples of polyamine chain extenders include diethyltoluenediamine, chlorodiam inobenzene, diethanolamine, diisopropanolamine, triethanolamine, tripropanolamine, 1,6-hexanediamine, and combinations thereof. The diamine crosslinking agents include twelve carbon atoms or fewer, more commonly seven or fewer. Other cross-linking agents include various tetrols, such as erythritol and pentaerythritol, pentols, hexols, such as dipentaerythritol and sorbitol, as well as alkyl glucosides, carbohydrates, polyhydroxy fatty acid esters such as castor oil and polyoxy alkylated derivatives of poly-functional compounds having three or more reactive hydrogen atoms, such as, for example, the reaction product of trimethylolpropane, glycerol, 1,2,6-hexanetriol, sorbitol and other polyols with ethylene oxide, propylene oxide, or other alkylene epoxides or mixtures thereof, e.g., mixtures of ethylene and propylene oxides.

Non-limiting examples of chain extenders include, but are not limited to, compounds having hydroxyl or amino functional group, such as glycols, amines, diols, and water. Specific non-limiting examples of chain extenders include ethylene glycol, diethylene glycol, propylene glycol, dipropylene glycol, 1,3-propanediol, 1,4-butanediol, 1,3-butanediol, 1,5-pentanediol, neopentyl glycol, 1,6-hexanediol, 1,9-nonanediol, 1,10-decanediol, 1,12-dodecanediol, ethoxylated hydroquinone, 1,4-cyclohexanediol, N-methylethanolamine, N-methylisopropanolamine, 4-aminocyclohexanol, 1,2-diaminoethane, 2,4-toluenediamine, or any mixture thereof. At times, the chain extenders are 1,3-propanediol, 1,6-hexanediol, 1,4-butanediol, or 1,9-nonanediol.

As needed for the TPEU synthesis, a suitable solvent may be used. Commonly used solvents may be chosen from the group including but not limited to aliphatic hydrocarbons (e.g., hexane and cyclohexane), organic esters (e.g., ethyl acetate), aromatic hydrocarbons (e.g., benzene and toluene), ethers (e.g., dioxane, tetrahydrofuran, ethyl ether, tert-butyl methyl ether), halogenated hydrocarbons (e.g., dicholoromethane and chloroform), and other solvents (e.g., N,N-dimethylformamide (DMF), dimethyl sulfoxide (DMSO)).

Also as needed for the TPEU synthesis, a suitable catalyst may be used. The catalyst component may include tertiary amines, organometallic derivatives or salts of, bismuth, tin, iron, antimony, cobalt, thorium, aluminum, zinc, nickel, cerium, molybdenum, vanadium, copper, manganese and zirconium, metal hydroxides and metal carboxylates. Tertiary amines may include, but are not limited to, triethylamine, triethylenediamine, N,N,N′,N′-tetramethylethylenediamine, N,N,N′,N′-tetraethylethylenediamine, N-methylmorpholine, N-ethylmorpholine, N,N,N′,N′-tetramethylguanidine, N,N,N′,N′-tetramethyl-1,3-butanediamine, N,N-dimethylethanolamine, N,N-diethylethanolamine. Suitable organometallic derivatives include di-n-butyl tin bis(mercaptoacetic acid isooctyl ester), dimethyl tin dilaurate, dibutyl tin dilaurate, dibutyl tin sulfide, stannous octoate, lead octoate, and ferric acetylacetonate. Metal hydroxides may include sodium hydroxide and metal carboxylates may include potassium acetate, sodium acetate or potassium 2-ethyl hexanoate.

### TPEU Synthesis Procedure

### Materials

DESMOPHEN® 2000 (molecular weight 2000 g/mol), the petroleum based poly(ethylene adipate) diol (PEAD) used was procured from Bayer Materials Science, Canada. 1,7-heptamethylene diisocyanate (HPMDI) was synthesized according to a previously reported procedure. The petroleum-based stannous octoate (Sn(Oct)2) catalyst, 1,4-butanediol (BD), 1,6-hexanediol (HD), 1,9-nonanediol (ND) and the 1, 3-propanediol (PD) were purchased from Sigma Aldrich, Canada. All these four diols, namely, BD, HD, ND, and PD, are also obtainable from bio-based sources. Chloroform, methanol, and DMF were obtained from ACP chemical Int. (Montreal, Quebec, Canada). All reagents except DMF was used as obtained. DMF was purified by drying overnight using 4A molecular sieves followed by a vacuum distillation (˜20 mm Hg).

### TPEU Synthesis

A series of HPMDI based TPEUs were prepared by reaction of poly(ethylene adipate) diol (PEAD) and/or aliphatic diol chain extenders (PD, BD, HD and ND) with bio-based diisocyanate, HPMDI, by using the industrially used one-shot (Method 1 and 2), pre-polymer (Method 3 and 4) and the multi stage polyaddition (Method 5) polymerization methods. The NCO:OH ratio for all TPEU samples was fixed at 1.1:1.

Table 1 provides the nomenclature and the chemical composition of the TPEUs. The samples were labelled based on the chemical composition of the repeating units represented as [CₘI]ₓ-[P(CₘI)_{y}]_{z}, where [CₘI]ₓ is the hard segment block (HS-block) with x number of repeating HPMDI-chain extender units. The soft segment block [P(CₘI)_{y}]_{z} included polyester diol (P=2000 g/mol) linked to either HPMDI (I) (y=1 when (CₘI)_{y=0}) or (CₘI)_{y} units and had a length given by z number of repeating units. TPEUs were designated according to the following structure:
PU[method #]-[HS-block content] [x_{(no. of repeating HS-block units)}]-[PEAD content] [y_{(no. of repeating CO units in SS-block)}]/[z_{(no. of repeating SS block units}]-[m], where PU denotes TPEUs and m represents the number of methylene groups in the aliphatic diol chain extender (Cₘ)

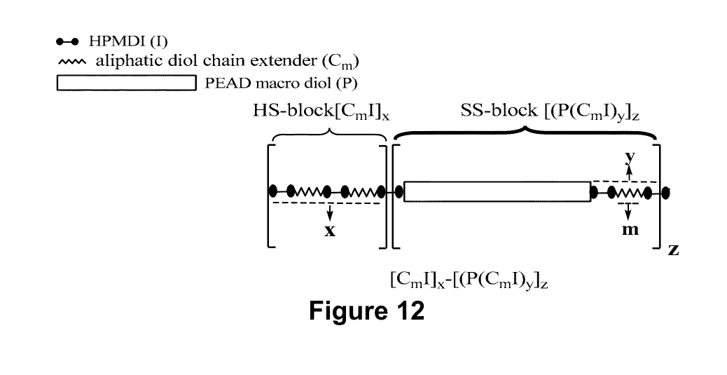

A schematic representation of the TPEU repeating unit structure is shown in FIG. 12. The molar ratios as well as the sequence of addition of various reagents are summarized in the table below.

TABLE 1
Sample designation and chemical composition of
TPEUs. The aliphatic diol chain extenders (Cₘ)
are m = 3 (PD), 4(BD), 6(HD) and 9 (ND).

| | | | | HS-block | | SS -block | | |
|---|---|---|---|---|---|---|---|---|
| | | | | [CₘI]ₓ | | [P(CₘI)_{y}]_{z} | | |
| | | | | HS | | P | | |
| Se- | | Meth- | Cₘ | (wt | | (wt | | |
| ries | TPEUs | od | m= | %) | x | %) | y | z |
| S1 | PU1-100x-0y₀/z₀-9 | 1 | 9 | 100 | — | — | — | — |
| | PU3-74x₅-24y₀/z₁-9 | 3 | 9 | 74 | 5 | 24 | 0 = I | 1 |
| | PU3-56x₄-40y₀/z₁-9 | 3 | 9 | 56 | 4 | 40 | 0 = I | 1 |
| | PU3-46x₃-49y₀/z₁-9 | 3 | 9 | 46 | 3 | 49 | 0 = I | 1 |
| | PU3-36x₂-58y₀/z₁-9 | 3 | 9 | 36 | 2 | 58 | 0 = I | 1 |
| | PU3-16x₁-76y₀/z₁-9 | 3 | 9 | 16 | 1 | 76 | 0 = I | 1 |
| | PU4-3x₁-88y₀/z₃-9 | 4 | 9 | 3 | 1 | 88 | 0 = I | 3 |
| | PU2-0x₀-92y₀/z₇₄ | 2 | — | — | — | 92 | 0 = I | 74 |
| S2 | PU3-46x₃-49y₀/z₁-9 | 3 | 9 | 46 | 3 | 49 | 0 = I | 1 |
| | PU5-46x₀₋₁-49y₂/z₁-9 | 5 | 9 | 46 | 0-1 | 49 | 2 | 1 |
| | PU5-46x₀₋₂-49y₁/z₁-9 | 5 | 9 | 46 | 0-2 | 49 | 1 | 1 |
| | PU4-46x₀₋₃-49y₀/z₁-9 | 4 | 9 | 46 | 0-3 | 49 | 0 = I | 1 |
| | PU3-16x₁-76y₀/z₁-9 | 3 | 9 | 16 | 1 | 76 | 0 = I | 1 |
| | PU4-16x₀₋₂-76y₀/z₁-9 | 4 | 9 | 16 | 0-2 | 76 | 0 = I | 1 |
| S3 | PU5-46x₀₋₂-49y₁/z₁-9 | 5 | 9 | 46 | 0-2 | 49 | 1 | 1 |
| | PU5-46x₀₋₂-49y₁/z₁-6 | 5 | 6 | 46 | 0-2 | 49 | 1 | 1 |
| | PU5-46x₀₋₂-49y₁/z₁-4 | 5 | 4 | 46 | 0-2 | 49 | 1 | 1 |
| | PU5-46x₀₋₂-49y₁/z₁-3 | 5 | 3 | 46 | 0-2 | 49 | 1 | 1 |

TABLE 2
Formulation of HPMDI (I), PEAD macro diol (P), and aliphatic
diol chain extenders (Cₘ where m = 9 (ND), 6 (HD), 4(BD)
and 3 (PD)) molar ratios used for the preparation of TPEUs.

| | | Act I | | | Act II | | Act III |
|---|---|---|---|---|---|---|---|
| Method | TPEUs | HPMDI | Cₘ | PEAD | Cₘ | PEAD | Cₘ |
| 1 | PU1-100x-0y₀/z₀-9 | 2 | 1.8 | — | — | — | — |
| 2 | PU2-0x₀-92y₀/z₇₄ | 2 | — | 1.8 | — | — | — |
| 3 | PU3-74x₅-24y₀/z₁-9 | 2 | 1.7 | 0.1 | — | — | — |
| | PU3-56x₄-40y₀/z₁-9 | 2 | 1.6 | 0.2 | — | — | — |
| | PU3-46x₃-49y₀/z₁-9 | 2 | 1.5 | 0.3 | — | — | — |
| | PU3-36x₂-58y₀/z₁-9 | 2 | 1.4 | 0.4 | — | — | — |
| | PU3-16x₁-76y₀/z₁-9 | 2 | 1.0 | 0.8 | — | — | — |
| 4 | PU4-46x₀₋₃-49y₀/z₁-9 | 2 | — | 0.3 | 1.5 | — | — |
| | PU4-16x₀₋₂-76y₀/z₁-9 | 2 | — | 0.8 | 1.0 | — | — |
| | PU4-3x₁-88y₀/z₃-9 | 2 | — | 1.5 | 0.3 | — | — |
| 5 | PU5-46x₀₋₁-49y₂/z₁-9 | 2 | 1.3 | — | — | 0.3 | 0.2 |
| | PU5-46x₀₋₂-49y₁/z₁-9 | 2 | 1 | — | — | 0.3 | 0.5 |
| | PU5-46x₀₋₂-49y₁/z₁-6 | 2 | 1 | — | — | 0.3 | 0.5 |
| | PU5-46x₀₋₂-49y₁/z₁-4 | 2 | 1 | — | — | 0.3 | 0.5 |
| | PU5-46x₀₋₂-49y₁/z₁-3 | 2 | 1 | — | — | 0.3 | 0.5 |

### One-Shot Method (Methods 1 and 2)

An excess amount of HPMDI (5.5 mmol) was dissolved initially in 16 mL of anhydrous DMF under a N2 atmosphere in a three-neck flask, and stirred. In Method 1, the 1,9-nonanediol and Sn(Oct)2 dissolved in anhydrous DMF (20 mg/5 mL) was added through an addition funnel fitted to the three-neck flask. The reaction mixture was then stirred at 80° C. for 3 h (act 1). The 1,9-nonanediol was substituted by PEAD in Method 2 (Table 1) and reacted at 85° C. for 4 h. Schematics of the reaction are given in Scheme 1. The reaction mixtures were precipitated into a large excess of warm distilled water (˜50° C.). The solid obtained was filtered and dried before purification by dissolving in CHCl3 (1 g/10 mL) and a subsequent precipitation using excess methanol (methanol/chloroform=10:1). The powder obtained was dried and melt pressed at 150° C. to make films at a controlled cooling rate of 5° C./min on a Carver 12 ton hydraulic heated bench press (Model 3851-0, Wabash, Ind., USA).

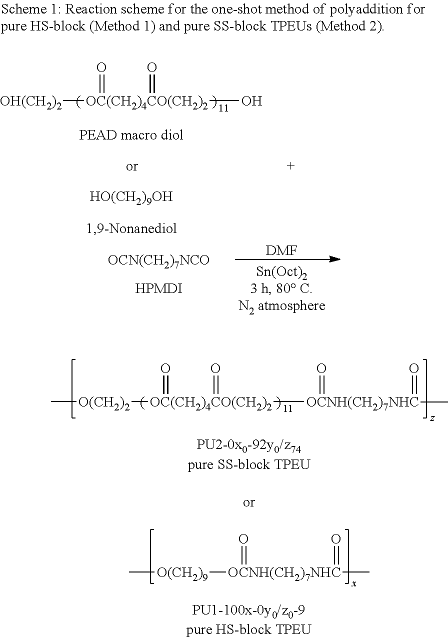

### Pre-Polymer Method (Methods 3 & 4)

In the pre-polymer method, varying ratios of HPMDI and 1,9-nonanediol (Method 3) (Table 2) was reacted according to act 1 of the previous method to prepare aliphatic diol-HPMDI pre-polymer mixtures. PEAD and catalyst dissolved in anhydrous DMF were introduced into the pre-polymer mixture in act 2 and reacted at 85° C. for another 20 h. Methods 3 and 4 differed only in the sequence of addition of the PEAD and 1,9-nonanediol reacting species. The 1,9-nonanediol reagent for act 1 reaction is replaced with PEAD in Method 4. Consequently, in act 2, the PEAD-HPMDI pre-polymers obtained were reacted with 1,9-nonanediol in the presence of catalyst at 85° C. for 20 h. The reaction schemes for Methods 3 and 4 polymerization are provided in Scheme 2. The reaction mixtures were purified and molded into films following the same procedure as in the previous method.

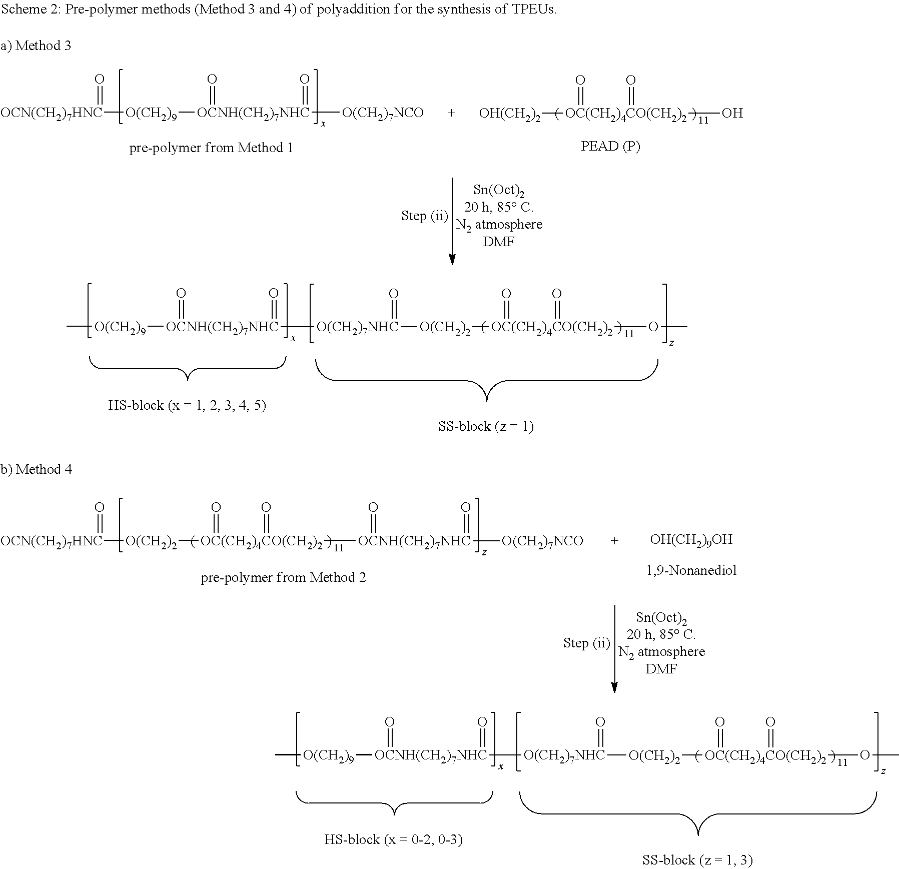

### Multi-Stage Polyaddition Method (Method 5)

In the multi-stage polyaddition method, a small fraction (Table 2) of chain extender solution (1 g/10 mL in anhydrous DMF) containing Sn(Oct)2 catalyst (20 mg/5 mL anhydrous DMF) was first added to HPMDI solution taken in a three neck flask under a N2 atmosphere, and stirred. The reaction mixture was heated to 80° C. and reacted for 3 h to obtain chain extended HPMDI pre-polymers (act 1). In act 2, PEAD solution (1 g/10 mL in anhydrous DMF) containing Sn(Oct)2 catalyst (20 mg/5 mL anhydrous DMF) was added (Scheme 3), and the temperature was raised to 85° C. The reaction was continued for another 4 h. In act 3, the remaining fraction of the chain extender solution (1 g/10 mL in anhydrous DMF) containing Sn(Oct)2 catalyst (20 mg/5 mL anhydrous DMF) was added and reacted for another 16 h. The product was purified and molded into films following the previously stated procedure.

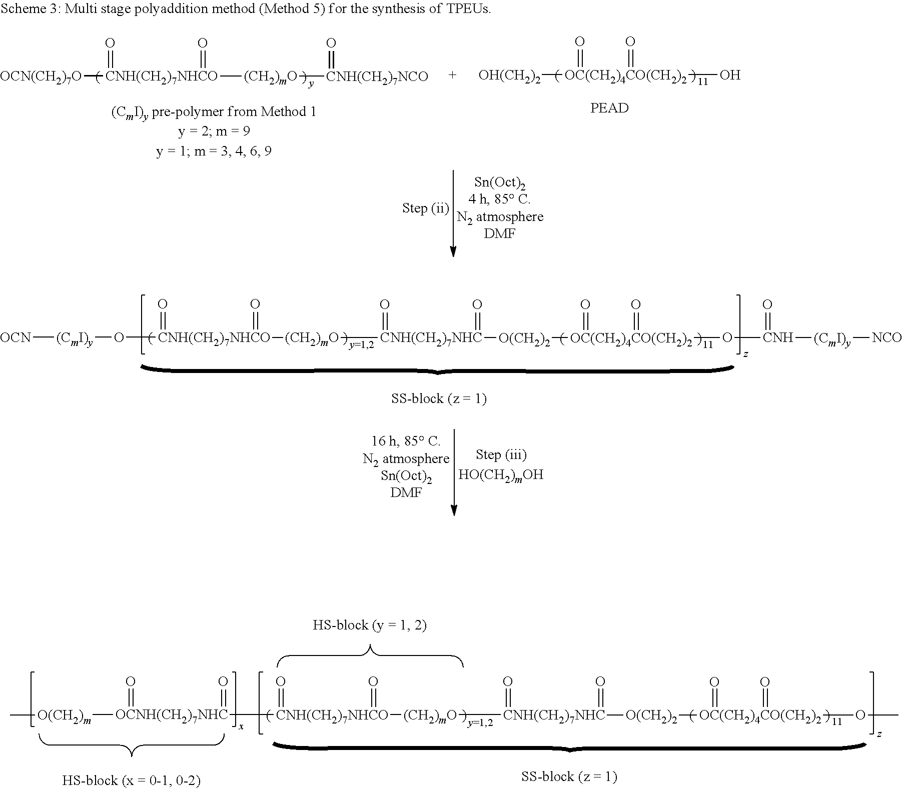

Analytical Characterization Techniques of TPEUs ¹H-NMR was used to analyze the pre-polymers and the final TPEU polymers. The spectra were recorded on a Bruker Advance III 400 spectrometer (Bruker BioSpin MRI GmbH, Karlsruhe, Germany) at a frequency of 400 MHz, using a 5-mm BBO probe, and were acquired at 25° C. over a 16-ppm spectral window with a 1-s recycle delay, and 32 transients. NMR spectra were Fourier transformed, phase corrected, and baseline corrected. Window functions were not applied prior to Fourier transformation. Chemical shifts were referenced relative to residual solvent peaks.

Gel Permeation Chromatography (GPC) was used to determine the number average molecular weight (Mn), weight-average molecular weight (Mw) and polydispersity index (the distribution of molecular mass, PDI=Mw/Mn) of TPEUs. GPC tests were carried out on a Waters Alliance (Milford, Mass., USA) e2695 separation module (Milford, Mass., USA), equipped with Waters 2414 refractive index detector and a Styragel HR5E column (5 μm). Chloroform was used as eluent with a flow rate of 0.5 mL/min. The sample was made with a concentration of 2 mg/mL, and the injection volume was 30 μl for each sample. Polystyrene Standards (PS, #140) were used to calibrate the curve.

Calorimetric studies of TPEUs were performed on a DSC Q200 (TA instrument, Newcastle, Del., USA) following the ASTM D3418 standard procedure under a dry nitrogen gas atmosphere. The sample (5.0-6.0 mg) was first heated to 180° C., and held at that temperature for 5 min to erase the thermal history; then cooled down to −90° C. with a cooling rate of 3° C./min. The sample was heated again (referred to as the second heating cycle) with a constant heating rate of 3° C./min from −90° C. to 180° C.

Thermogravimetric Analysis was carried out using a TGA Q500 (TA instrument, Newcastle, Del., USA.) following the ASTM E2550-11 standard procedure. Samples of −10 mg were heated from room temperature to 600° C. under dry nitrogen at constant heating rates of 10° C./min.

The static mechanical properties of the synthesized polymer films were determined at room temperature (RT=25° C.) by uniaxial tensile testing using a Texture Analyzer (Texture Technologies Corp, NJ, USA) following the ASTM D882 procedure. The sample was stretched at a rate of 5 mm/min from a gauge of 35 mm.

The crystalline structure of selected TPEUs was examined by wide-angle X-ray diffraction (WAXD) on an EMPYREAN diffractometer system (PANanalytical, The Netherlands) equipped with a filtered Cu—Kα radiation source (λ=1.540598 Å), and a PIXcel³D area detector. TPEU samples were crystallized from the melt at a controlled cooling rate of 5° C./min. The scanning range was from 3.3° to 35° (28) with a step size of 0.013°; 2414 points were collected in this process. The deconvolution of the spectra and data analysis was performed using PANanalytical's X′Pert HighScore 3.0.4 software. For weakly crystalline TPEUs the diffraction peaks characteristic of the crystalline phase was superimposed on a broad halo indicative of the presence of an amorphous phase. The amorphous contribution to the WAXD pattern was fitted with a linear combination of two lines (centered at 4.0 and 4.7 Å) as customarily done for semi crystalline polymers.

### Experimental Results and Discussion

As referenced previously, three series of high molecular weight TPEUs were prepared by reacting bio-based diisocyanate (HPMDI) with aliphatic diols (Cₘ) and a PEAD macro diol (2000 g/mol), by utilizing five different polymerization methods (Schemes 1-3, Table 2). Table 3 details the composition, molecular weight and the renewable carbon content (RCC, wt %) obtained for these multi block polymers. TPEUs in S1 series have varying HS-block content (0-100 wt %) ([CₘI]ₓ-[P(CₘI)_{y}]_{z}: x and z varies while m and y are constant) with a fixed PEAD chain length (2000 g/mol).

The S2 series TPEUs have a same gross composition, e.g., a fixed HS-block content (46 and 16 wt %), but a varying distribution of HS block ([CₘI]ₓ) units. TPEUs belonging to S3 series have fixed HS-block content as well as distribution, but with a variation in the methylene chain lengths of the chain extender (Cₘ) units.

TABLE 3
Synthesis results for [CₘI]ₓ-[P(CₘI)_{y}]_{z} TPEUs: The
PEAD:Cₘ ratio, the number of (CₘI) repeating unit in SS-
block ([P(Cml)_{y}]_{z}) for TPEU copolymer in the feed and
in the copolymers (exp., determined (from ¹H-NMR)), aver-
age molecular weight (M_{w}) and PDI (determined from GPC),
the percentage renewable carbon content (RCC) in wt %.

| | | PEAD:Cₘ molar | | | | | | |
|---|---|---|---|---|---|---|---|---|
| | | ratio | | y | | GPC | | |
| | | in the | | in the | | M_{w} | | % |
| Series | TPEUs | feed | exp. | feed | exp. | (kg/mol) | PDI | RCC |
| S1 | PU1-100x-0y₀/z₀-9 | | — | 0 | 0 | — | — | 100 |
| | PU3-74x₅-24y₀/z₁-9 | 0.75:1 | 0.82:1 | 0 | 0 | 3200 | 1.1 | 76 |
| | PU3-56x₄-40y₀/z₁-9 | 1.53:1 | 1.61:1 | 0 | 0 | 3600 | 1.1 | 60 |
| | PU3-46x₃-49y₀/z₁-9 | 2.30:1 | 2.36:1 | 0 | 0 | 3300 | 1.0 | 51 |
| | PU3-36x₂-58y₀/z₁-9 | 2.57:1 | 3.22:1 | 0 | 0 | 3700 | 1.0 | 42 |
| | PU3-16x₁-76y₀/z₁-9 | 9.2:1 | 9.18:1 | 0 | 0 | 760 | 5.8 | 24 |
| | PU4-3x₁-88y₀/z₃-9 | 57.5:1 | 52.9:1 | 0 | 0 | 720 | 5.4 | 22 |
| | PU2-0x₀-92y₀/z₇₄ | — | — | | | 170 | 7.2 | 8 |
| S2 | PU3-46x₃-49y₀/z₁-9 | 2.30:1 | 2.36:1 | 3 | 2.86 | 3330 | 1.04 | 51 |
| | PU5-46x₀₋₁-49y₂/z₁-9 | 2.4:1 | 2.39:1 | 2 | 1.86 | 2800 | 1.04 | 51 |
| | PU5-46x₀₋₂-49y₁/z₁-9 | 2.4:1 | 2.36:1 | 1 | 1.15 | 3480 | 1.03 | 51 |
| | PU4-46x₀₋₃-49y₀/z₁-9 | 2.30:1 | 2.40:1 | 0 | 0 | 3310 | 1.04 | 51 |
| | PU3-16x₁-76y₀/z₁-9 | 9.2:1 | 9.18:1 | 0 | 0 | 760 | 5.8 | 24 |
| | PU4-16x₀₋₂-76y₀/z₁-9 | 9.2:1 | 9.42:1 | 0 | 0 | 840 | 5.5 | 24 |
| S3 | PU5-46x₀₋₂-49y₁/z₁-9 | 2.4:1 | 2.36:1 | 1 | 1.15 | 3480 | 1.03 | 51 |
| | PU5-46x₀₋₂-49y₁/z₁-6 | 2.4:1 | 2.78:1 | 1 | 1.05 | 3360 | 1.03 | 51 |
| | PU5-46x₀₋₂-49y₁/z₁-4 | 2.4:1 | 3.12:1 | 1 | 1.14 | 3270 | 1.03 | 51 |
| | PU5-46x₀₋₂-49y₁/z₁-3 | 2.4:1 | 3.20:1 | 1 | 1.11 | 3260 | 1.04 | 51 |

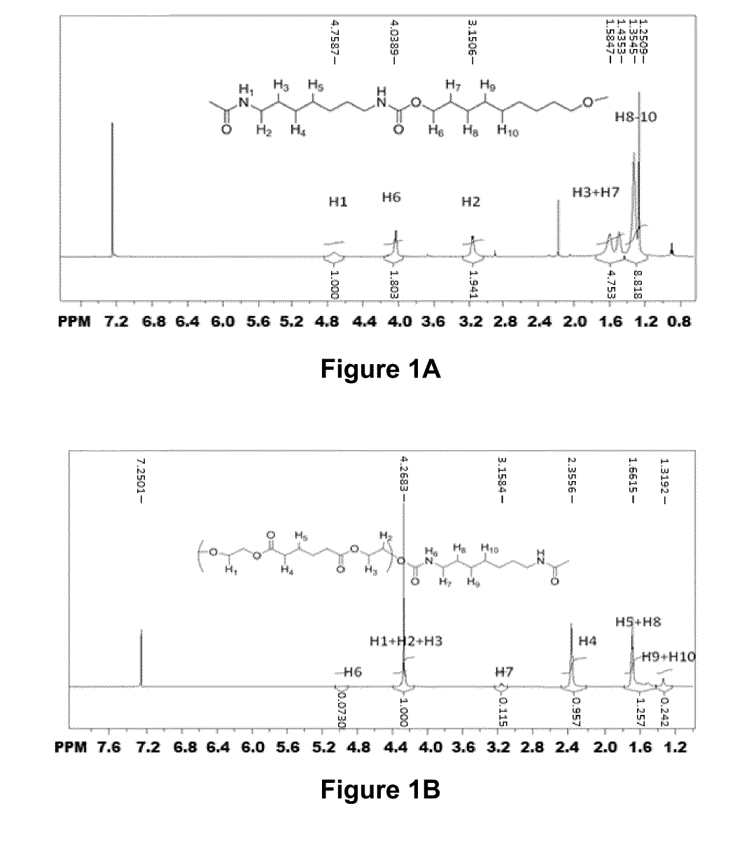

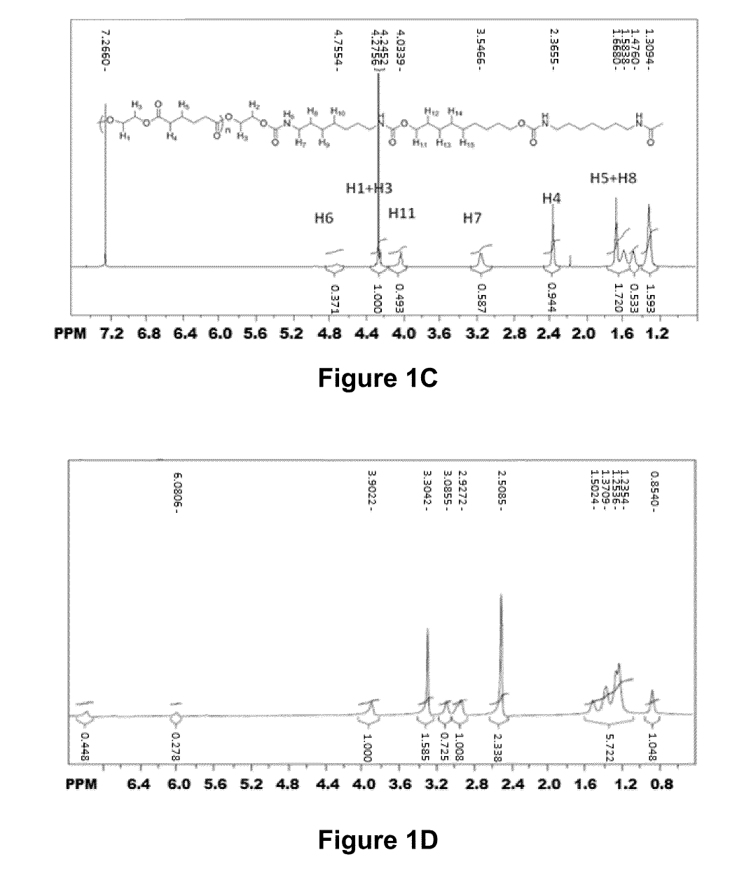

The composition of TPEUs was estimated from ¹H-NMR using the relative intensities of the proton peaks arising from PEAD macro diol and the aliphatic diol (Cₘ, m=3, 4, 6, 9) units. FIGS. 1A-D show the ¹HNMR spectrums for the pure HS-block (PU1-100x-0y₀/z₀-9) and SS-block TPEUs (PU2-0x₀-92y₀/z₇₄), and also for a PU5-46x₀₋₂-49y₁/z₁-9 sample with 2.36/1 molar ratio of PEAD/Cₘ=9 (feed composition, Table 3). The spectrum of pure HS-block TPEU (FIG. 1A) showed characteristic chemical shifts of the urethane linkages. The single peak at 4.72 ppm is attributed to —CH₂NHC (═O) O—, the proton (marked 1 in FIG. 1A) attached to the nitrogen in the urethane linkage, δ=4.04 ppm to —NHC(═O) O—CH₂— (marked 6 in FIG. 1A), and δ=3.15 ppm to —CH₂NHC(═O) O— (marked 2 in FIG. 1A). The ¹H-NMR spectrum (FIG. 1B) showed chemical shift at δ=5.0 ppm attributed to —OCH₂CH₂O—C(═O) NH— (marked 6 in FIG. 1B). The chemical shifts at δ=4.26 ppm to —OCH₂CH₂O— (marked 1, 2 and 3 in FIG. 1B), δ=3.15 ppm to —CH₂NHC(═O) O— (marked 7 in FIG. 1B), and δ=2.37 ppm is attributed to —CH₂O—C(═O) CH₂— (marked 4 in FIG. 1B) in polyester diol unit. The peak positions in the ¹H-NMR spectra for TPEUs containing both PEAD and Cₘ units (example, FIG. 1C) were identical to those for pure HS- and SS-block TPEUs. The PEAD: Cₘ mole fractions for TPEUs were estimated from the relative peak intensities of the proton peaks at δ=4.26 and δ=4.04 ppm. A good agreement was obtained between the initial and final values (Table 3).

For S2 and S3 series of TPEUs, the sequence distribution (x:y) of HS-blocks was also determined by ¹H-NMR analysis. Aliquots of the (CₘI)_{y} hard segment pre-polymer samples obtained after act 1 were end-capped by reacting with dibutyl amine, and analyzed by ¹H NMR (FIG. 1D). The value was calculated based on the ratio of peak intensities for the proton peaks at δ=3.89 ppm (—CH₂NHC(═O) O—) and at δ=0.86 ppm (—CH₃) between the pre-polymer (CₘI)_{y} hard segments and the final products. Excellent agreement between the experimental and calculated values suggested controlled HS-block lengths for S2 and S3 series of TPEUs.

For the S3 series of TPEUs, with decreasing m, the proton peaks due to —NHC(═O)O—CH₂— was observed at lower magnetic fields. This is due to the deferent effect of the electron-withdrawing effects by the urethane groups on the CH₂ moieties. In Table 3, the PEAD: Cₘ molar ratio obtained from ¹H-NMR analysis for S3 series of TPEUs decreased with CH2 chain length (m) due probably to some trans-esterification reaction between the chain extender (Cₘ) methylene units and (CH₂)2 unit of PEAD. The chemical shift of the transesterification product is overlapped at δ=4.26-4.24 ppm.

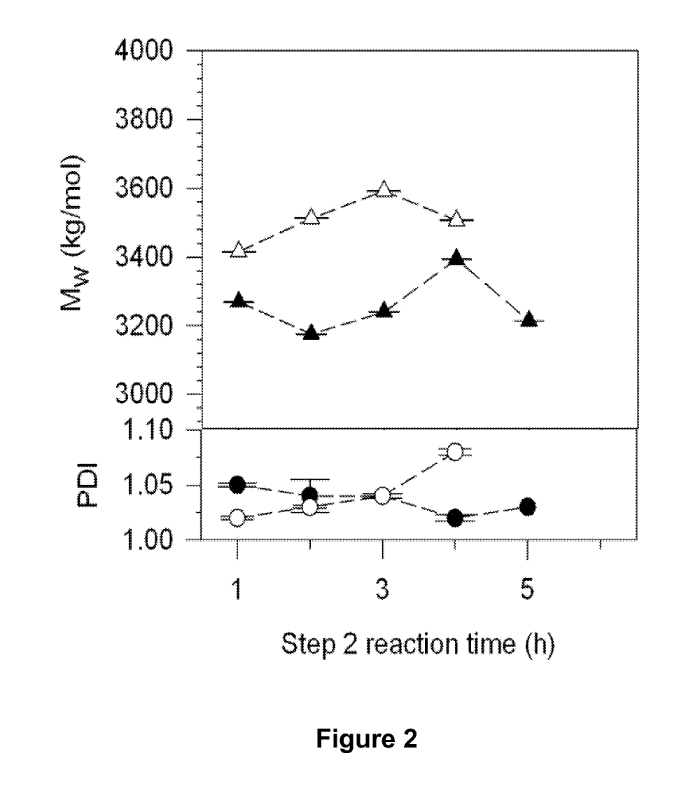

The weight average molar mass (M_{w}) and polydispersity index (PDI) of the TPEUs determined by GPC are also listed in Table 3. The TPEU chains were sufficiently long so that they had little effect on the physical properties, and the size, distribution and composition of the block segments determined the macroscopic properties. Samples had good solubility in DMF and chloroform. The poor solubility of PU1-100x-0y₀/z₀-9 in chloroform at room temperature (RT=25° C.) restricted its molar mass as determination by GPC. The large chain length and low PDI values for TPEU suggested high reactivity of bio-based HPMDI towards polyaddition reactions. FIG. 2 shows the variation of M_{w} and PDI with reaction time (t) during the second act for Methods 3 and 4. As can be seen from the figure, the maximum molecular weight was achieved within a short reaction time of 3-4 h.

### Physical Properties of TPEUs

### Crystallization and Melting Behavior of TPEUs

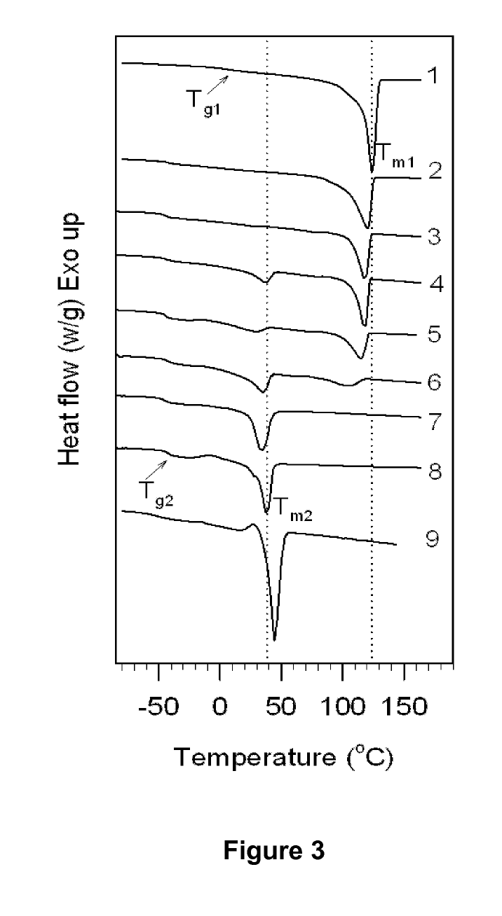

FIG. 3 shows the DSC thermograms for TPEUs of the S1 series with varying HS-block content (0-100 wt %). The corresponding melting parameters and glass transition temperatures (T_{g}) are summarized in Table 4.

TABLE 4
Characteristic parameters of TPEUs obtained by DSC. onset, (Tₒₙ₁ &Tₒₙ₂) offset, (T_{off1} _{&}
T_{off2}), peak (Tₘ₁& Tₘ₂) temperatures of melting, and enthalpies of melting (ΔHₘ₁ & ΔHₘ₂) of high and
low temperature peaks 1 (HS-block) and 2 (SS-block), obtained from the second heating cycle. T_{g1} and
T_{g1}: glass transition temperatures for HS- and SS- blocks, respectively. The uncertainties attached
to the characteristic temperatures and enthalpies are better than 1.0° C. and 5 J/g, respectively.

| | | HS-block | | | | | SS-block | | | | |
|---|---|---|---|---|---|---|---|---|---|---|---|
| Series | TPEUs | Tₒₙ₁ | Tₘ₁ | T_{off1} | ΔHₘ₁ | T_{g1} | Tₒₙ₂ | Tₘ₂ | T_{off2} | ΔHₘ₂ | T_{g2} |
| S1 | PU1-100x-0y₀/z₀-9 | 92.1 | 124.1 | 129.5 | 71 | 4.5 | — | — | — | — | — |
| | PU3-74x₅-24y₀/z₁-9 | 83.0 | 119.8 | 125.1 | 55 | — | — | — | — | — | −42.6 |
| | PU3-56x₄-40y₀/z₁-9 | 81.5 | 117.1 | 123.2 | 35 | — | — | — | — | — | −42.5 |
| | PU3-46x₃-49y₀/z₁-9 | 81.7 | 117.6 | 122.9 | 33 | — | 1.9 | 37.6 | 44.6 | 14 | −41.6 |
| | PU3-36x₂-58y₀/z₁-9 | 93.5 | 115.5 | 122.87 | 23 | — | −1.4 | 25.2 | 38.9 | 10 | −41.5 |
| | PU3-16x₁-76y₀/z₁-9 | 72.4 | 102.6 | 117.5 | 10 | — | 1.7 | 31.6 | 42.5 | 30 | −39.6 |
| | PU4-3x₁-88y₀/z₃-9 | — | — | — | — | — | 2.5 | 34.3 | 43.5 | 42 | −41.6 |
| | PU2-0x₀-92y₀/z₇₄ | — | — | — | — | — | 6.2 | 38.5 | 44.0 | 49 | −39.0 |
| | PEAD | — | — | — | — | — | 26.7 | 52 | 57.0 | 72 | −51.2 |
| S2 | PU3-46x₃-49y₀/z₁-9 | 81.7 | 117.6 | 122.9 | 33 | — | 1.9 | 37.6 | 44.6 | 14 | −41.6 |
| | PU5-46x₀₋₁-49y₂/z₁-9 | 92.8 | 115.4 | 120.9 | 30 | — | 11.1 | 35.5 | 46.2 | 14 | −41.9 |
| | PU5-46x₀₋₂-49y₁/z₁-9 | 99.0 | 118.1 | 123.0 | 33 | — | 2.7 | 26.1 | 39.5 | 6 | −41.5 |
| | PU4-46x₀₋₃-49y₀/z₁-9 | 75.7 | 116.8 | 122.5 | 31 | — | 3.1 | 31.1 | 41.0 | 7 | −41.9 |
| | PU3-16x₁-76y₀/z₁-9 | 72.4 | 102.6 | 117.5 | 10 | — | 1.7 | 31.6 | 42.5 | 30 | −39.6 |
| | PU4-16x₀₋₂-76y₀/z₁-9 | 63.1 | 93.1 | 101.4 | 5 | — | −3.6 | 25.0 | 39.4 | 17 | −40.0 |
| S3 | PU5-46x₀₋₂-49y₁/z₁-9 | 81.7 | 117.6 | 122.9 | 33 | — | 1.9 | 37.6 | 44.6 | 14 | −41.6 |
| | PU5-46x₀₋₂-49y₁/z₁-6 | 110.3 | 126.6 | 132.3 | 30 | — | 3.4 | 25.5 | 40.7 | 6 | −41.2 |
| | PU5-46x₀₋₂-49y₁/z₁-4 | 108.2 | 137.1 | 142.9 | 17 | — | −2.7 | 26.6 | 40.8 | 7 | −41.0 |
| | PU5-46x₀₋₂-49y₁/z₁-3 | 100.5 | 132.4 | 141.9 | 23 | — | 9.6 | 29.6 | 42.1 | 6 | −40.6 |
| | | | 121.9* | | | | | | | | |

The pure HS-block TPEU (PU1-100x-0y₀/z₀-9) exhibited two thermal transition regions during the second heating. The glass transition of amorphous [Cₘ₌₉I]ₓ units of HPMDI-ND chains appeared at 4.5±0.5° C. (T_{g1}, Table 4) and the melting transition, Tₘ₁, peaked at 124.1±0.2° C. (enthalpy of 71±0.4 J/g, Table 4). The pure SS-block TPEU (PU2-0x₀-92y₀/z₇₄) exhibited a glass transition (T_{g}2=−38.5±0.1° C.) and a sharp melting by PEAD (P) units (T_{m2=38.5}° C., ΔHₘ₂=49 J/g, Table 4) at relatively lower temperatures than HS-blocks. The melting point as well as the crystallinity of PEAD segment in TPEUs, as reflected by the enthalpy values was much lower than pure PEAD, which suggests that the crystallites are relatively less stable and less organized than in the pure PEAD macro diol. An estimation of the degree of HS-block crystallinity for HPMDI based TPEUs was restricted by the lack of fusion enthalpy data for 100% crystalline HPMDI-ND systems. The pure HS-block TPEU is a unique aliphatic m, n polyurethane [O—(CH₂)ₘ—OC(O)—NH—(CH₂)ₙ—NH—C(O)] where m=9 and n=7 represent the uninterrupted methylene groups originating from the Cₘ₌₉ diol and HPMDI (n=7). The PU1-100x-0y₀/z₀-9 melt transition data is however consistent with those obtained for its closest analogues, namely, the 8, 6 aliphatic polyurethane (162° C. and 60 J/g) and 10, 6 polyurethane (161° C. and 51 J/g).

The SS-block glass transition of TPEUs, as shown in Table 4, was only slightly larger than pure PEAD (T_{g}2=−38.5±0.1° C.) and was also independent of the HS-block content (24-92%, S1 series), distribution (S2 series) and type (Cₘ: m=3, 4, 6, 9-S3 series), indicating a relatively small amount of hard segments mixing with the amorphous PEAD segments. The slightly higher value obtained for T_{g}2 compared to pure PEAD arose from the restrictions placed at the PEAD soft segment chain ends by the covalently linked HS-blocks. No separate HS-block T_{g} was detected, which may be the case reported for segmented TPEUs even though an amorphous phase of HS-blocks normally exists for these types of TPEUs.

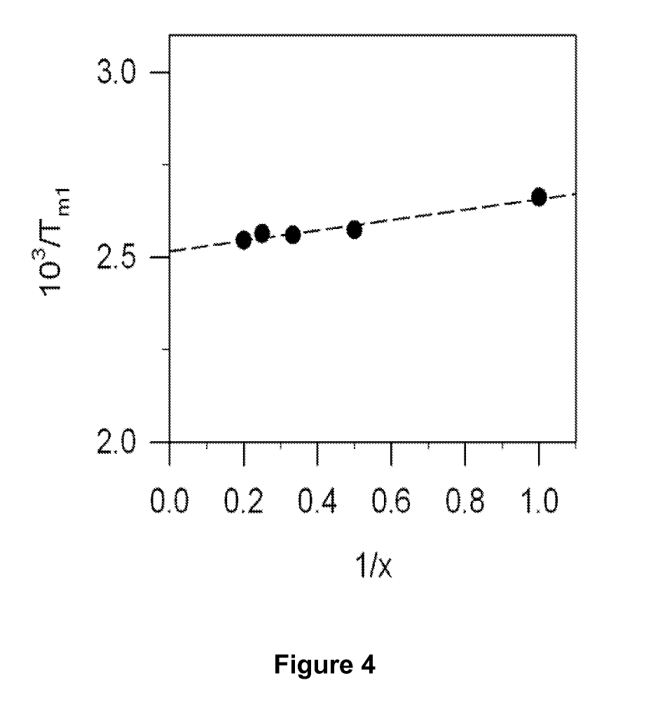

The data in Table 4 indicate that the crystallinity of both the HS- and SS-blocks was impacted by the content (S1 series), distribution (S2 series), and type (S3 series) of HS-block units. For series 1 TPEUs, the low HS-content (3 wt %) inhibited the crystallization of HS-blocks in PU4-3x₁-88y₀/z₃-9 and resulted in amorphous HS domains. The HS-block melting temperature (Tₘ₁) increased with increasing number of repeating HS-block units (x=1-5; HS content=16-74 wt %) and approached that of PU1-100x-0y₀/z₀-9 having the same composition as the repeating HS-block unit. The fusion enthalpies, reflecting the degree of crystallinity, also increased with x. Since DSC indicated minimal miscibility between HS- and SS-blocks, the well-known Flory's correlation between HS melting point and size (x) was tested for 51 polyurethanes.

$$\frac{1}{{T}_{m}} = \frac{2 R}{x {\overline{H}}_{x}} + \frac{1}{{T}_{m}^{o}} \qquad ( 1 )$$

where Tₘ is the melting point, R the gas constant, x the number of repeat units, H̅ₓ the average heat of fusion per repeat unit, and Tₘ^{o} the melting point of the infinite polymer. FIG. 4 plots the reciprocal absolute melting temperature of HS-blocks against the reciprocal average degree of polymerization (x). Irrespective of the presence of SS-block, the reciprocal Tₘ₁ exhibits a linear dependence on 1/x suggesting that the HS-blocks crystallized freely as if they were isolated oligomers not linked by the SS-block.

The development of SS-block melting transition for S1 series TPEUs was also investigated. As seen from Table 4, the lower PEAD content TPEUs (24-40%) did not exhibit any thermal transition indicative of crystalline ordering within the SS-blocks. This suggested that crystallization of PEAD units with fixed length (2000 g/mol) was limited due possibly to a confinement effect by the strongly crystallizing HS-blocks. PEAD crystallinity, however, was observed in TPEUs with a higher PEAD content (>49%). The PEAD melting temperature and enthalpy varied with HS-block content (Table 4). Interestingly, for TPEUs with intermediate PEAD contents (e.g., 49-76%), both HS- and SS-blocks were capable of crystallization and the SS-block melting temperature varied between room temperature (RT=25° C.) and the melting temperature of pure SS-block TPEU.

The PEAD confinement by HS-blocks was further investigated for S2 series TPEUs having a fixed HS-block content and PEAD chain lengths, but with varying distribution of HS block lengths (x, y). For TPEUs with 46% HS-block content (PU3-46x₃-49y₀/z₁-9), the PEAD melting temperature and enthalpy increased with increasing distribution of HS-blocks ([Cₘ₌₉I]x with x varying from 3 and 0-3). In PU4-46x₀₋₃-49y₀/z₁-9 sample with a broad distribution of HS-blocks, (Cₘ₌₉I)ₓ₌₃, the hard segment blocks crystallized to a high level of ordering and restricted the space available for the crystallization of the PEAD chains, thereby decreasing Tₘ₂ and enthalpy values (Table 4). This finding was of significant technical importance as one can control the crystallization of soft segments by controlling the dispersion of hard segment blocks in semi-crystalline PEUs.

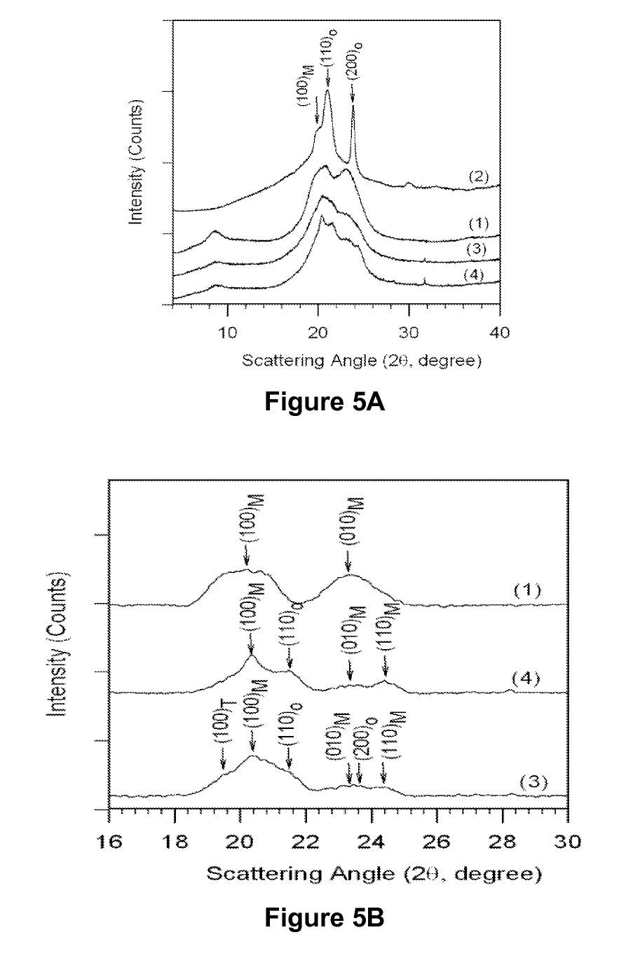

The crystal structures of the TPEUs were analyzed using WAXD. FIGS. 5A-B show the WAXD patterns for pure SS-block (PU2-0x₀-92y₀/z₇₄) and HS-block (PU1-100x-0y₀/z₀-9) TPEUs, as well as for PU3-46x₃-49y₀/z₁-9 and PU4-46x₀₋₃-49y₀/z₁-9 having different HS block distributions. The WAXD pattern for PU2-0x₀-92y₀/z₇₄ indicated sharp diffraction peaks at d-spacing of 4.23 Å (110) and 3.75 Å (200) peaks corresponding to an orthorhombic crystal subcell. The PEAD chains crystallize by folding into an orthorhombic unit cell in order to maximize the van der Waals interactions between the chains. A weak shoulder is also observed at around 4.45 Å (marked by an arrow in FIG. 5A, and listed in Table 5). At high PEAD content (92 wt %) the relatively small number of HPMDI-urethane bonds present in SS-block is not sufficient for the polymer to exhibit any crystallinity related to the strongly hydrogen-bonded urethane linkages, confirming what was previously established by DSC.

In order to show the crystalline peaks more prominently and reveal the phase type of PU1-100x-0y₀/z₀-9, PU3-46x₃-49y₀/z₁-9 and PU4-46x₀₋₃-49y₀/z₁-9, the background and the amorphous contribution were subtracted from their WAXD patterns and presented in FIG. 5B. Indexing of the WAXD lines were performed by comparing the experimental reflections to similar forms observed in aliphatic m, n polyurethanes, polyesters, polyamides (PA)s, as well as polyester urethanes (PEU)s. Table 5 lists the structural data obtained from the WAXD.

TABLE 5
WAXD structural data for selected TPEUs. Bragg distances,
dₕₖₗ, are listed with their associated (hkl) indices. Relative
Bragg peak intensities of the crystalline phase obtained after
subtraction of the background and amorphous contributions are
indicated by subscripts; s: strong, m: medium, w: weak.

| | Subcell structure | | | | | |
|---|---|---|---|---|---|---|
| | Monoclinic | | Orthorhombic | | Triclinic | |
| sample | d(\acute{Å}) | hkl | d(\acute{Å}) | hkl | d(\acute{Å}) | hkl |
| PU2-0x₀-92y₀/z₇₄ | 4.45w | (100) | 4.23s | (110) | | |
| | | | 3.75m | (200) | | |
| PU3-46x₃-49y₀/z₁-9 | 4.36s | (100) | 4.13w | (110) | | |
| | 3.80w | (010) | | | | |
| | 3.64m | (110) | | | | |
| PU4-46x₀₋₃-49y₀/z₁-9 | 4.37s | (100) | 4.11m | (110) | 4.60w | (100) |
| | 3.82w | (010) | 3.76w | (200) | | |
| | 3.62m | (110) | | | | |
| PU1-100x-0y₀/z₀-9 | 4.41s | (100) | | | | |
| | 3.82m | (010) | | | | |
| | 3.63w | (110) | | | | |

The WAXD pattern for PU1-100x-0y₀/z₀-9 presented diffraction peaks at 4.41 Å, 3.82 Å and 3.63 Å attributable to (100), (010) and (110) reflections of a monoclinic subcell. In this crystal structure, the HPMDI-ND (Cₘ₌₉I)ₓ chain segments form planar sheets in order to maximize the contribution of the C═O . . . H—N hydrogen bonds between adjacent chains. The WAXD pattern for both PU4-46x₀₋₃-49y₀/z₁-9, and PU3-46x₃-49y₀/z₁-9 displayed the (100), (010), and (200) reflections of the monoclinic symmetry and (110) and (200) reflections of an orthorhombic subcell. The intensity of the peaks originating from the monoclinic phase due to HS-blocks were much higher than the weak peaks of the PEAD orthorhombic phase. Another very weak scattering peak was observed in the WAXD pattern of PU4-46x₀₋₃-49y₀/z₁-9 at 4.6 Å attributable to the characteristic (100) reflection of a triclinic phase, labeled T. The high level of HS-block ordering was also evident from the unchanged melting temperature and enthalpy values for the HS-block in these TPEUs. A distribution of hard blocks in PU4-46x₀₋₃-49y₀/z₁-9 sample crystallizes into identical close packing (comparable) but imposes constraints to crystallization of PEAD soft blocks and pushes the PEAD melting down further to lower temperatures.

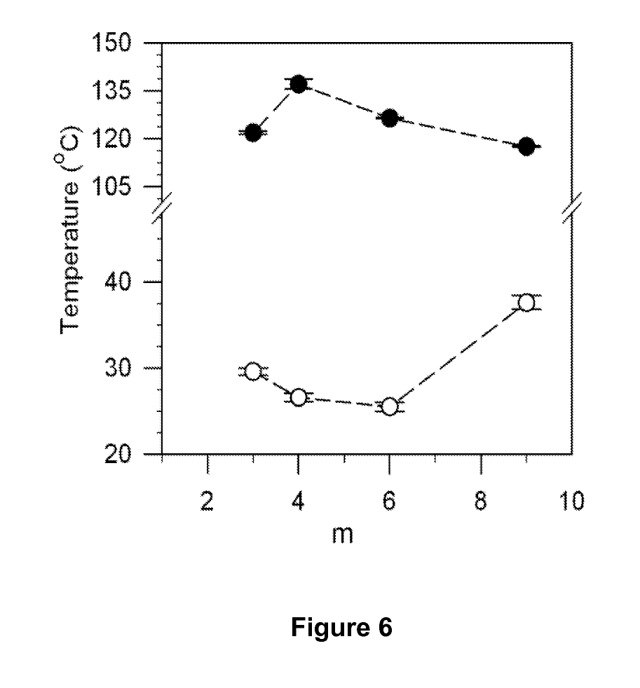

The HS- and SS-block crystallization for PU5-46x₀₋₂-49y₁/z₁-m samples as a function of the chain extender methylene chain length (Cₘ where m=3, 4, 6, 9: S3 series) was also investigated. An odd-even effect on HS-block melting temperature (Tₘ₁) was observed for S3 series of TPEUs (FIG. 6).

The PU5-46x₀₋₂-49y₁/z₁-4 sample with 1,4-butanediol chain extended HPMDI hard block units gave the highest melting temperature (Tₘ₁=142.9±0.6° C.), which is explained by the unique conformations adopted by even numbered (m=4) methylene chains to maximize the urethane-urethane H-bonding. Interestingly, the PEAD melting (Tₘ₂) was affected by the HS-block odd-even effects. As seen from FIGS. 5A-B and Table 4, the PEAD melting temperatures for TPEUs with HS blocks having even m values (m=4 and 6) is lower than those TPEUs having HS-blocks with odd m values.

### Mechanical Properties of the TPEUs

Mechanical performance of the HPMDI based TPEUs were evaluated by measuring the initial modulus, tensile strength and extensibility, and was further compared with petroleum-based TPEUs prepared from PEAD and butanediol chain extender and petroleum based diisocyanates, as outlined in Table 6.

TABLE 6
Mechanical properties obtained from tensile analysis of
the TPEUs, PEAD, 1,4-butanediol and petroleum based
di-isocyanates such as NDI (pNaphthylene1, 5 diisocyanate),
p-PDI (p-phenylene diisocyanate), TDI (Toluene 2,4
diisocyanate), MDI (Diphenyl methane 4,4′-diisocyanate),
and TODI (3,3′ Dimethyl 4,4′-diisocyanate). Initial
modulus (E), ultimate elongation at break (EB) and ultimate
tensile strength (TS)

| | | E | TS | EB |
|---|---|---|---|---|
| Series | TPEUs | (MPa) | (MPa) | (%) |
| S1 | PU1-100x-0y₀/z₀-9 | — | — | — |
| | PU3-74x₅-24y₀/z₁-9 | 420 ± 13 | 16.1 ± 0.4 | 6.8 ± 1.3 |
| | PU3-56x₄-40y₀/z₁-9 | 248 ± 5 | 12.4 ± 1.2 | 79 ± 8.5 |
| | PU3-46x₃-49y₀/z₁-9 | 215 ± 12 | 10.0 ± 0.4 | 80 ± 7.9 |
| | PU3-36x₂-58y₀/z₁-9 | 83 ± 3 | 22.8 ± 0.8 | 543 ± 14 |
| | PU3-16x₁-76y₀/z₁-9 | 146 ± 14 | 20.7 ± 1.1 | 608 ± 40 |
| | PU4-3x₁-88y₀/z₃-9 | 270 ± 30 | 31.4 ± 1.5 | 758 ± 30 |
| | PU2-0x₀-92y₀/z₇₄ | 228 ± 20 | 20.6 ± 1.5 | 692 ± 50 |
| S2 | PU3-46x₃-49y₀/z₁-9 | 215 ± 12 | 10.0 ± 0.4 | 80 ± 7.9 |
| | PU5-46x₀₋₁-49y₂/z₁-9 | 221 ± 18 | 10.0 ± 0.5 | 24.2 ± 5.3 |
| | PU5-46x₀₋₂-49y₁/z₁-9 | 201 ± 9 | 8.9 ± 0.2 | 11.6 ± 1.0 |
| | PU4-46x₀₋₃-49y₀/z₁-9 | 110 ± 5 | 17.2 ± 0.2 | 323 ± 45 |
| | PU3-16x₁-76y₀/z₁-9 | 146 ± 14 | 20.7 ± 1.1 | 608 ± 40 |
| | PU4-16x₀₋₂-76y₀/z₁-9 | 62 ± 10 | 29.9 ± 1.2 | 755 ± 80 |
| S3 | PU5-46x₀₋₂-49y₁/z₁-9 | 201 ± 9 | 8.9 ± 0.2 | 11.6 ± 1.0 |
| | PU5-46x₀₋₂-49y₁/z₁-6 | 129 ± 2 | 25.1 ± 1.1 | 357 ± 40 |
| | PU5-46x₀₋₂-49y₁/z₁-4 | 105 ± 3 | 26.5 ± 0.6 | 469 ± 1 |
| | PU5-46x₀₋₂-49y₁/z₁-3 | 143 ± 2 | 16.0 ± 0.3 | 243 ± 2 |
| | NDI | — | 29 | 500 |
| | p-PDI | — | 44 | 600 |
| | TDI | — | 31 | 600 |
| | MDI | — | 54 | 600 |
| | TODI | — | 27 | 400 |

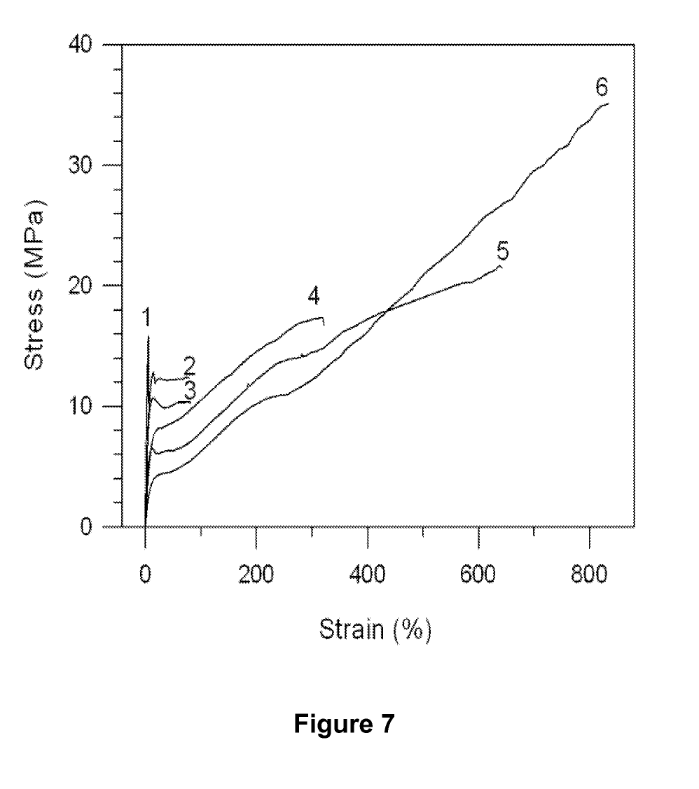

The pure HS-block polymer, PU1-100x-0y₀/z₀-9 was too brittle to make tensile specimens. The S1 series TPEUs demonstrated deformation behavior ranging from that of a plastic (ductile) to one of an elastomer (rubber-like) depending on the HS-block content. For TPEUs with higher HS-block content (>49 wt %) the stress-strain curves showed plastic failure with limited extensibility (% EB of 6-80%, FIG. 7). For PU3-74x₅-24y₀/z₁-9, PU3-56x₄-40y₀/z₁-9, and PU3-46x₃-49y₀/z₁-9 TPEUs, and for deformation beyond the yield point, the linear stress-strain region fails, and the plastic deformation begins by necking that extends until the ultimate tensile strength is reached. The low HS-content TPEUs, for example in PU3-16x₁₋₇₆y₀/z₁-9 sample, the stress-strain curves displayed sigmoidal shaped stress-strain curves including an initial steep increase in stress followed by yielding and strain hardening regions such as in certain rubber-like elastomers.

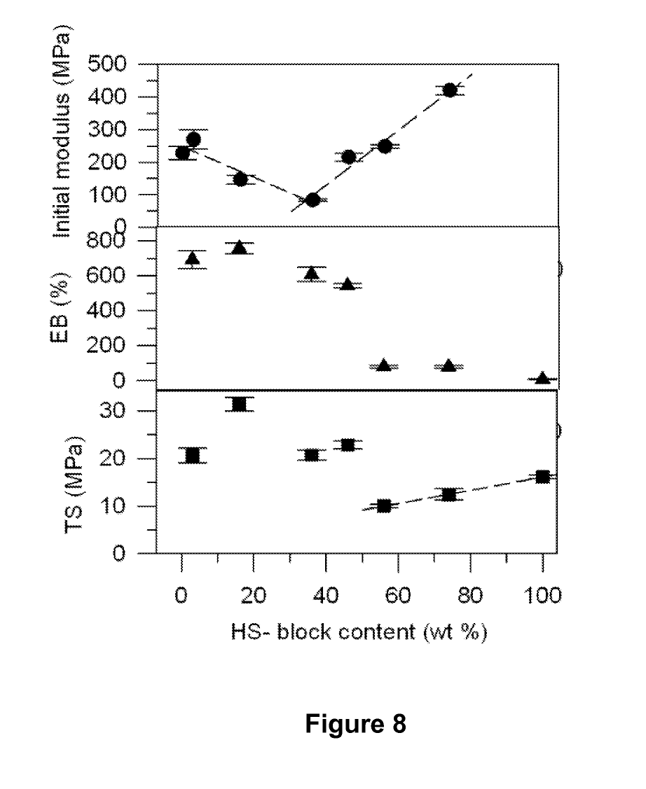

FIG. 8 shows the variations in initial modulus, ultimate strength and extensibility for TPEUs with varying HS-block content. The modulus and strength decreased whereas the extensibility increased with HS-block content as expected for conventional TPEUs having crystalline HS-blocks. Interestingly, beyond 36 wt % HS-block content, contrary to the behavior for classical polyurethane elastomers, the initial modulus values increased with decreasing HS-block content due to a reinforcement effect by the SS-block crystallites. The reinforcement effect by SS-block crystallites also explains the increased ultimate tensile strength for the high HS-content TPEUs. Similar reinforcement effect due to polyester crystallites has been reported for PEO, poly(butylene adipate glycol), and PCL based polyurethanes.

The low HS-content TPEUs, PU4-3x₁-88y₀/z₃-9 and the pure SS-block PU2-0x₀-92y₀/z₇₄, which lack crystallization by HS-blocks (refer DSC data, Table 4) but have crystallized SS-blocks instead, exhibited enhanced tensile strength (FIG. 8, Table 6), initial modulus (FIG. 8, Table 6) and % EB (FIG. 8, Table 6) values. The superior toughness of these TPEUs is attributable to the deformation of rigid SS-block crystallites at elongations beyond yield point, followed by the strain induced crystallization of the rubbery amorphous PEAD soft segments.

It is notable that the SS-block crystallites play a significant role in the mechanical performance of TPEUs. For semi-crystalline TPEUs with constant HS block content (S2 series) the tensile strength and extensibility increased with increasing distribution (x) of the HS-blocks (Table 6). This notably contradicts the behavior of classical segmented TPEUs where monodisperse HS-blocks were shown to offer higher tensile strength and modulus, due to a better phase separation and close packing. The PU3-46x₃-49y₀/z₁ sample, for example, deformed plastically whereas PU3-46x₃-49y₀/z₁, with the same HS-block content but x varying from 0 to 3, is an elastomer (Table 6). This was clearly a product of the latter possessing SS-block crystallites with a room temperature melting transition (DSC data, Table 4). The SS-block crystallites reinforce the polymer matrix at temperatures below their melting transition. The SS-block crystallites with a room temperature melting transition undergo reversible matrix reinforcements during deformation due to soft segment chain mobility that allows for the newly formed junctions to serve as load bearing phases and thereby improve the toughness.

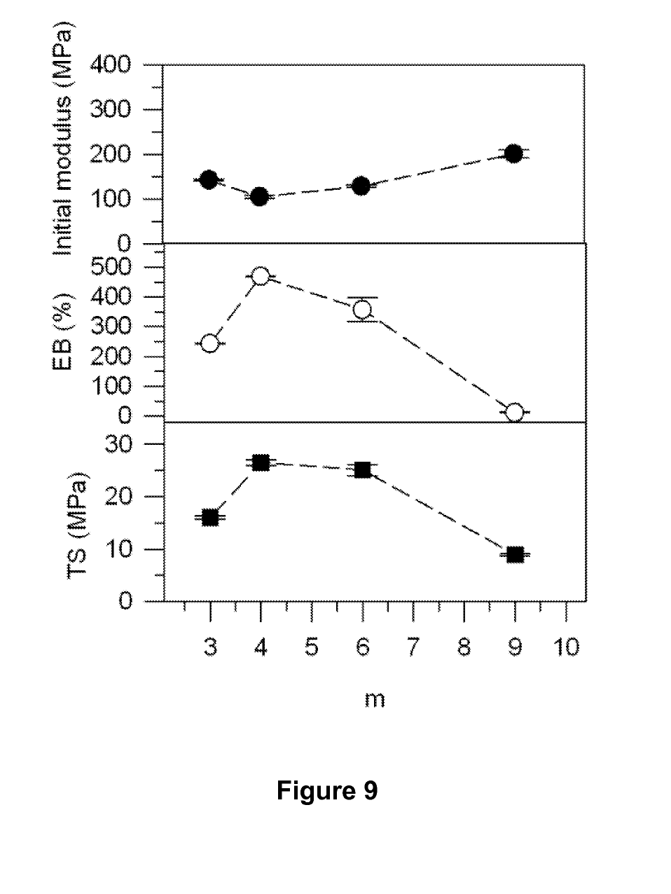

For S3 series TPEUs having fixed HS-block content (46 wt %) and distribution (x=0-2, y=1) but vary only in their chain extender lengths (Cₘ, m=3, 4, 6, 9), the mechanical properties strongly resembled their HS-block odd-even melting behavior. As seen in FIG. 9, PU5-46x₀₋₂-49y₁/z₁-4 having the highest Tₘ₁ (most stable HS-block crystals) and lowest enthalpy gave the highest value for strength and elongation, but the lowest values for initial modulus. This trend is consistent with results reported for TPEUs with 1,4-butanediol chain extender. The strength and extensibility values for PU5-46x₀₋₂-49y₁/z₁-4 with 1,4-butanediol chain extended HPMDI units were comparable to those of TPEUs prepared from PEAD macrodiol, BD and petroleum based di-isocyanates, as is listed in Table 6.

### Thermal Degradation Behavior of TPEUs

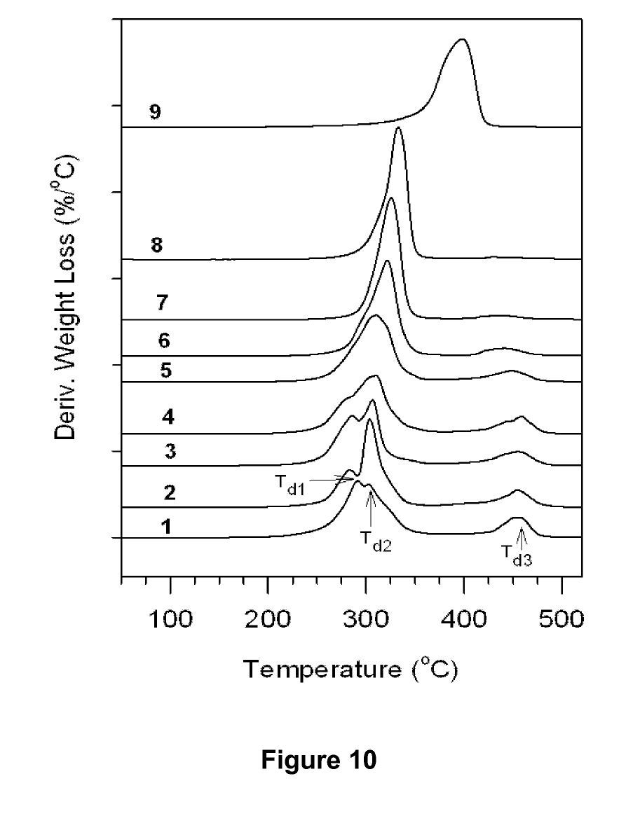

The thermal stability of TPEUs was investigated using TGA analysis at a heating rate of 10° C./min. Example DTG curves obtained for the S1 series are shown in FIG. 10. The onset temperatures of decomposition, T_{d(onset)}, determined at 5.0% weight loss, DTG peak temperatures (T_{d1}, T_{d2} and T_{d3}), and the weight loss obtained for each decomposition stage (ΔW₁ and ΔW₂) for TPEUs of the S1, S2 and S3 series are given in Table 7. Pure PEAD displayed a single DTG peak at around 398±0.4° C., similar with certain aliphatic polyesters where the degradation is initiated by a random scission of the ester linkage at the alkyl-oxygen bond, followed by pyrolysis at temperatures around 370-440° C.

TABLE 7
Onset temperature of thermal degradation (T_{d(onset)}) determined
at 5.0% weight loss; Peak decomposition temperatures (T_{d1},
T_{d2} and T_{d3}) obtained from the DTG curves. All temperatures
are in ° C. Weight loss (ΔW₁ and ΔW₂, %) calculated for
each decomposition stage. The uncertainties attached to the
characteristic temperatures and weight loss are better than
2.0° C. and 2%, respectively.

| | | TGA/DTG | | |
|---|---|---|---|---|
| | | T_{d(onset)} | T_{d1}/T_{d2}/T_{d3} | ΔW₁/ΔW₂ |
| Series | TPEUs | (° C.) | (° C.) | (%) |
| S1 | PU1-100x-0y₀/z₀-9 | 250.5 | 290.5/301.9/454.2 | 71/19 |
| | PU3-74x₅-24y₀/z₁-9 | 262.0 | 282.1/302.6/454.6 | 73/18 |
| | PU3-56x₄-40y₀/z₁-9 | 256.2 | 285.2/306.4/456.3 | 62/19 |
| | PU3-46x₃-49y₀/z₁-9 | 263.0 | 280.2/309.0/458.7 | 74/18 |
| | PU3-36x₂-58y₀/z₁-9 | 267.6 | 310.1/448.6 | 73/13 |
| | PU3-16x₁-76y₀/z₁-9 | 288.6 | 321.0/441.8 | 80/9 |
| | PU4-3x₁-88y₀/z₃-9 | 295.8 | 325.7/438.0 | 82/6 |
| | PU2-0x₀-92y₀/z₇₄ | 296.6 | 332.2/430.9 | 88/3 |
| | PEAD | 301.9 | 398.7/— | 97/0 |
| S2 | PU3-46x₃-49y₀/z₁-9 | 263.0 | 280.2/309.0/458.7 | 74/18 |
| | PU5-46x₀₋₁-49y₂/z₁-9 | 260.5 | 313.9/456.8 | 69/20 |
| | PU5-46x₀₋₂-49y₁/z₁-9 | 263.3 | 310.3/456.8 | 74/18 |
| | PU4-46x₀₋₃-49y₀/z₁-9 | 263.3 | 312.2/454.5 | 74/17 |
| | PU3-16x₁-76y₀/z₁-9 | 288.6 | 321.0/441.8 | 80/9 |
| | PU4-16x₀₋₂-76y₀/z₁-9 | 287.8 | 302/332.0/437.2 | 85/6 |
| S3 | PU5-46x₀₋₂-49y₁/z₁-9 | 263.4 | 310.3/456.8 | 74/18 |
| | PU5-46x₀₋₂-49y₁/z₁-6 | 267.8 | 313.0/456.1 | 75/19 |
| | PU5-46x₀₋₂-49y₁/z₁-4 | 260.7 | 310.6/449.6 | 75/21 |
| | PU5-46x₀₋₂-49y₁/z₁-3 | 262.5 | 307.0/442.7 | 69/20 |

PU1-100x-0y₀/z₀-9 exhibited a two-act degradation process. The decomposition of urethane bonds started at a temperature above 200° C. (250.5±0.8° C.), similarly to m, n aliphatic polyurethanes with high H-bond densities. Decomposition reaches its maximum rate at 290-301° C. (T_{d1} at 290.5±0.4 with a shoulder at T_{d2}=301.9±0.3° C.) accompanied by a major weight loss, ΔW₁. The more stable urethane structures in pure HS-block TPEU underwent decomposition during the second degradation stage (T_{d3}=454.2±0.8° C., ΔW₂=19±1.0%).

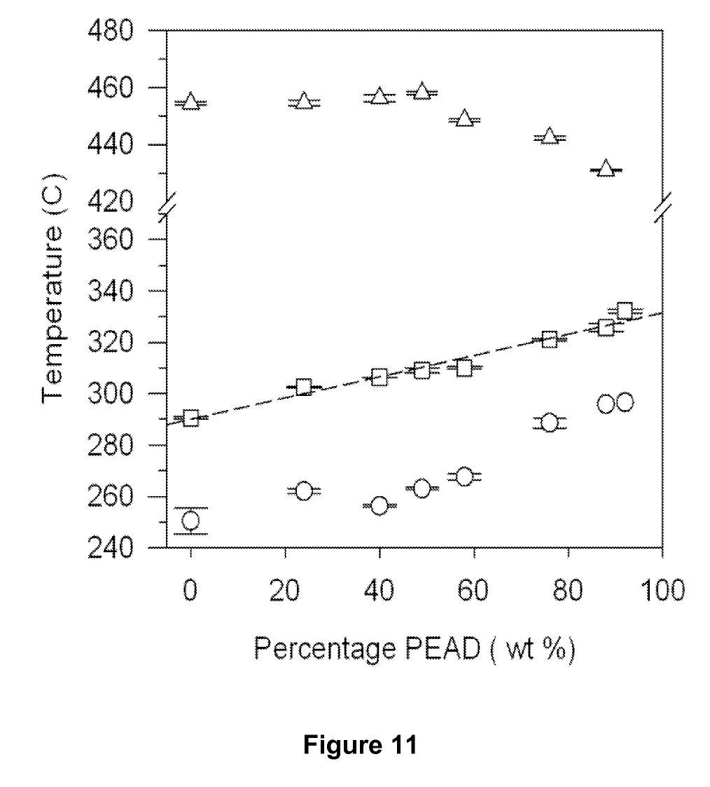

A higher initial decomposition temperature was recorded for S1 series TPEUs with PEAD SS-block contents as is shown in FIG. 10 (Table 7). The PEAD degradation event overlapped with urethane decomposition in TPEUs containing PEAD soft blocks, and their T_{d1} and T_{d2} values (FIG. 10) were therefore attributable to both urethane and polyester degradations. Their main DTG peak, T_{d(main)} (plotted in FIG. 11), which represents the major weight loss event, shifted linearly to higher values with increasing SS-block content. Meanwhile, the weight loss, ΔW₂, and T_{d3} peak (Table 6, FIG. 11), corresponding to thermally stable HS-block structures, shifted to lower values with increasing PEAD content for S1 series TPEUs. A similar decrease in T_{d3} peak values was also observed for S3 series of TPEUs with increasing values of m (Table 6). The thermal degradation behavior for S2 series of TPEUs does not vary significantly with HS-block distribution (x).

The decomposition temperatures for TPEUs derived from bio based HPMDI were not affected by the preparation methods and are comparable to the thermal stability temperatures (250-300° C.) reported for similar systems based on hexamethylene diisocyanate (HDI), the closest petroleum based analogue of HPMDI. Moreover, these materials can be processed by injection molding and extrusion since their thermal stabilities are well above the optimum thermoplastic processing window.

To review, high molecular weight thermoplastic polyester urethanes (TPEUs), [CₘI]ₓ-[P(CₘI)_{y}]_{z} with crystallizable hard ([CₘI]ₓ, HS-block) and soft blocks ([P(CₘI)_{y}]_{z}, SS-block) were prepared from vegetable oil-based HPMDI (I), PEAD macro diol (2000 g/mol) (P), and aliphatic diol chain extenders (Cₘ, m=3, 4, 6, 9) using one-shot, pre-polymer and multistage polyaddition methods. For fixed PEAD chain lengths (2000 g/mol) the relative roles of hard and soft segment thermal transitions on the mechanical performance was examined for varying content (x, y—series S1), distribution (x, y, z—series S2) and types (Cₘ, m=3, 4, 6, 9—series S3) of HS-block units in TPEUs. The HS-blocks including HPMDI-Cₘ₌₉ units crystallized freely into monoclinic crystal packing, whereas the crystallization of PEAD segments into orthorhombic symmetry was constrained by the HS-block ordering for TPEUs. For TPEUs with a fixed HS-block content (46 wt %), the SS-block melting temperature and enthalpies were lowered with increasing HS-block distribution, as well as by chain extenders with even numbered methylene groups (m=4, 6).

The semi-crystalline thermoplastic polyester urethane elastomers prepared from bio-based heptamethylene diisocyanate possess toughness and strength comparable to those made from petroleum-based diisocyanates. These TPEUs are thermally stable up to 250° C. A significant reinforcement effect due to PEAD crystallites mitigate the lowering of modulus and strength for elastomeric TPEUs at lower HS-block contents (<46 wt %). For TPEUs with fixed HS-block content (46 wt %, S2 series), the presence of SS-block crystallites imparted elastomeric properties to an otherwise thermoplastic TPEU. This study demonstrates that the control of hard segment crystallization has the potential for tailoring the soft segment crystalline behavior in TPEUs to achieve tunable mechanical properties.

The foregoing detailed description and accompanying figures have been provided by way of explanation and illustration, and are not intended to limit the scope of the invention. Many variations in the present embodiments illustrated herein will be apparent to one of ordinary skill in the art, and remain within the scope of the invention and their equivalents.

1. A thermoplastic polyester urethane composition having the formula [CₘI]ₓ-[P(CₘI)_{y}]_{z},
wherein:
(i) [CₘI]ₓ is a hard segment block present in an amount of 0% to 100% weight percent of the composition, and Cₘ is a chain extender where m is 9, I is a natural oil based organic isocyanate, and x is a number of repeating units of the hard segment, where x is 0 to 5, and
(ii) [P(CₘI)_{y}]_{z} is a soft segment block present in the amount of 0% to 92% weight percent of the composition, wherein P is a polyester diol, y is I when (CₘI)_{y}+0, and z is 0 to 74.

2. The composition of claim 1, wherein:
(i) the chain extender comprises glycols, amines, diols, and water;
(ii) the natural oil based organic isocyanate is represented by the formula R(NCO)ₙ, where n is 1 to 10, R comprises 2 to 40 carbon atoms, and wherein R contains at least one aliphatic, cyclic, alicyclic, aromatic, branched, aliphatic- and alicyclic-substituted aromatic, aromatic-substituted aliphatic and alicyclic group, and
(iii) the polyester diol is a hydroxyl terminated reaction product of dihydric alcohols and dicarboxylic acids or their ester derivatives.

3. The composition of claim 2, wherein:
(i) the chain extender is selected from the group consisting of ethylene glycol, diethylene glycol, propylene glycol, dipropylene glycol, 1,3-propanediol, 1,4-butanediol, 1,3-butanediol, 1,5-pentanediol, neopentyl glycol, 1,6-hexanediol, 1,9-nonanediol, 1,10-decanediol, 1,12-dodecanediol, ethoxylated hydroquinone, 1,4-cyclohexanediol, N-methylethanolamine, N-methylisopropanolamine, 4-aminocyclohexanol, 1,2-diaminoethane, 2,4-toluenediamine, and mixtures thereof;
(ii) the natural oil based organic isocyanate is selected from the group consisting of crude or distilled diphenylmethane-4,4′-diisocyanate (MDI); toluene-2,4-diisocyanate (TDI); toluene-2,6-diisocyanate (TDI); methylene bis 4-cyclohexylisocyanate (H₁₂MDI); 3-isocyanatomethyl-3,5,5-trimethyl-cyclohexyl isocyanate (IPDI); 1,6-hexane diisocyanate (HDI); naphthalene-1,5-diisocyanate (NDI); 1,3- and 1,4-phenylenediisocyanate; polyphenylpolymethylenepolyisocyanate (PMDI); m-xylene diisocyanate (XDI); 1,4-cyclohexyl diisocyanate (CHDI); isophorone diisocyanate; 1,7-heptamethylene diisocyanate (HPMDI); isomers and mixtures or combinations thereof; and
(iii) the polyester diol is selected from the group consisting of poly(ethylene adipate) diol, poly(ethylene succinate) diol, poly(ethylene sebacate) diol, and poly(butylene adipate) diol.

4. The composition of claim 1, wherein the composition comprises:
(i) a polyester diol to chain extender ratio of 0:0 to 0.75:1 to 57.5:1;
(ii) a weight average molecular weight from 0 kg/mol to 3700 kg/mol;
(iii) a polydispersity index of 0 to 7.2; and
(iv) a renewable carbon content of 8 to 100%.

5. The composition of claim 1, wherein the composition comprises:
(i) a hard segment block melting onset temperature of 0° C. to 93.5° C.;
(ii) a hard segment block peak melting temperature of 0° C. to 124.1° C.;
(iii) a hard segment block melting offset temperature of 0° C. to 129.5° C.; and
(iv) an enthalpy of melting of 0 J/g to 71 J/g.

6. The composition of claim 1, wherein the composition comprises:
(i) an initial modulus of 83±3 MPa to 420±13 MPa;
(ii) an ultimate tensile strength of 10.0±0.4 MPa to 31.4±1.5 MPa; and
(iii) an ultimate elongation at break of 6.8%±1.3% to 692%±50%.

7. The composition of claim 1, wherein the composition comprises:
(i) an onset temperature of thermal decomposition at 5% weight loss of 250.5° C. to 301.9° C.;
(ii) a peak decomposition temperature range of 280.2° C. to 458.7° C.; and
(iii) a percentage weight loss at decomposition of 0% to 97%.

8. A thermoplastic polyester urethane composition having the formula [CₘI]ₓ-[P(CₘI)_{y}]_{z} wherein:
(i) [CₘI]ₓ is a hard segment block present in an amount of 16% to 46% weight percent of the composition, and Cₘ is a chain extender where m is 9, I is a natural oil based organic isocyanate, and x is a number of repeating units of the hard segment, where x is 0 to 3, and
(ii) [P(CₘI)_{y}]_{z} is a soft segment block present in an amount of 49% to 76% weight percent of the composition, wherein P is a polyester diol, y is I when (CₘI)_{y=0} or 1 to 2, and z is 1.

9. The composition of claim 8, wherein:
(i) the chain extender comprises glycols, amines, diols, and water;
(ii) the natural oil based organic isocyanate is represented by the formula R(NCO)ₙ, where n is 1 to 10, and wherein R comprises 2 to 40 carbon atoms, and wherein R contains at least one aliphatic, cyclic, alicyclic, aromatic, branched, aliphatic- and alicyclic-substituted aromatic, aromatic-substituted aliphatic and alicyclic group, and
(iii) the polyester diol is a hydroxyl terminated reaction product of dihydric alcohols and dicarboxylic acids or their ester derivatives.

10. The composition of claim 9, wherein:
(i) the chain extender is selected from the group consisting of ethylene glycol, diethylene glycol, propylene glycol, dipropylene glycol, 1,3-propanediol, 1,4-butanediol, 1,3-butanediol, 1,5-pentanediol, neopentyl glycol, 1,6-hexanediol, 1,9-nonanediol, 1,10-decanediol, 1,12-dodecanediol, ethoxylated hydroquinone, 1,4-cyclohexanediol, N-methylethanolamine, N-methylisopropanolamine, 4-aminocyclohexanol, 1,2-diaminoethane, 2,4-toluenediamine, and mixtures thereof;
(ii) the natural oil based organic isocyanate is selected from the group consisting of crude or distilled diphenylmethane-4,4′-diisocyanate (MDI); toluene-2,4-diisocyanate (TDI); toluene-2,6-diisocyanate (TDI); methylene bis 4-cyclohexylisocyanate (Hi 2M DI); 3-isocyanatomethyl-3,5,5-trimethyl-cyclohexyl isocyanate (IPDI); 1,6-hexane diisocyanate (HDI); naphthalene-1,5-diisocyanate (NDI); 1,3- and 1,4-phenylenediisocyanate; polyphenylpolymethylenepolyisocyanate (PMDI); m-xylene diisocyanate (XDI); 1,4-cyclohexyl diisocyanate (CHDI); isophorone diisocyanate; 1,7-heptamethylene diisocyanate (HPMDI); isomers and mixtures or combinations thereof; and
(iii) the polyester diol is selected from the group consisting of poly(ethylene adipate) diol, poly(ethylene succinate) diol, poly(ethylene sebacate) diol, and poly(butylene adipate) diol.

11. The composition of claim 8, wherein the composition comprises:
(i) polyester diol to chain extender ratio of 2.30:1 to 9.42:1;
(ii) a weight average molecular weight from 760 kg/mol to 3480 kg/mol;
(iii) a polydispersity index of 1.04 to 5.8; and
(iv) a renewable carbon content of 24 to 51%.

12. The composition of claim 8, wherein the composition comprises:
(i) a hard segment block melting onset temperature of 63.1° C. to 99.0° C.,
(ii) a hard segment block peak melting temperature of 93.1° C. to 118.1° C.;
(iii) a hard segment block melting offset temperature of 101.4° C. to 123.0° C.; and
(iv) an enthalpy of melting of 5 J/g to 33 J/g.

13. The composition of claim 8, wherein the composition comprises:
(i) an initial modulus of 62±10 MPa to 221±18 MPa;
(ii) an ultimate tensile strength of 8.9±0.2 MPa to 29.9±1.2 MPa; and
(iii) an ultimate elongation at break of 80%±7.9% to 755%±80%.

14. The composition of claim 8, wherein the composition comprises:
(i) an onset temperature of thermal decomposition at 5% weight loss of 260.5° C. to 288.6° C.;
(ii) a peak decomposition temperature range of 280.2° C. to 458.7° C.; and
(iii) a percentage weight loss at decomposition of 6% to 85%.

15. A thermoplastic polyester urethane composition having the formula [CₘI]ₓ-[P(CₘI)_{y}]_{z} wherein:
(i) [CₘI]ₓ is a hard segment block present in an amount of 46% weight percent of the composition, and Cₘ is a chain extender where m is 3 to 9, I is a natural oil based organic isocyanate, and x is a number of repeating units of the hard segment, where x is 0 to 2, and
(ii) [P(CₘI)_{y}]_{z} is a soft segment block present in an amount of 49% weight percent of the composition, wherein P is a polyester diol, y is 1, and z is 1.

16. The composition of claim 15, wherein:
(i) the chain extender comprises glycols, amines, diols, and water;
(ii) the natural oil based organic isocyanate is represented by the formula R(NCO)ₙ, where n is 1 to 10, and wherein R comprises 2 and 40 carbon atoms, and wherein R contains at least one aliphatic, cyclic, alicyclic, aromatic, branched, aliphatic- and alicyclic-substituted aromatic, aromatic-substituted aliphatic and alicyclic group, and
(iii) the polyester diol is a hydroxyl terminated reaction product of dihydric alcohols and dicarboxylic acids or their ester derivatives.

17. The composition of claim 16, wherein:
(i) the chain extender is selected from the group consisting of ethylene glycol, diethylene glycol, propylene glycol, dipropylene glycol, 1,3-propanediol, 1,4-butanediol, 1,3-butanediol, 1,5-pentanediol, neopentyl glycol, 1,6-hexanediol, 1,9-nonanediol, 1,10-decanediol, 1,12-dodecanediol, ethoxylated hydroquinone, 1,4-cyclohexanediol, N-methylethanolamine, N-methylisopropanolamine, 4-aminocyclohexanol, 1,2-diaminoethane, 2,4-toluenediamine, and mixtures thereof;
(ii) the natural oil based organic isocyanate is selected from the group consisting of crude or distilled diphenylmethane-4,4′-diisocyanate (MDI); toluene-2,4-diisocyanate (TDI); toluene-2,6-diisocyanate (TDI); methylene bis 4-cyclohexylisocyanate (H₁₂MDI); 3-isocyanatomethyl-3,5,5-trimethyl-cyclohexyl isocyanate (IPDI); 1,6-hexane diisocyanate (HDI); naphthalene-1,5-diisocyanate (NDI); 1,3- and 1,4-phenylenediisocyanate; polyphenylpolymethylenepolyisocyanate (PMDI); m-xylene diisocyanate (XDI); 1,4-cyclohexyl diisocyanate (CHDI); isophorone diisocyanate; 1,7-heptamethylene diisocyanate (HPMDI); isomers and mixtures or combinations thereof; and
(iii) the polyester diol is selected from the group consisting of poly(ethylene adipate) diol, poly(ethylene succinate) diol, poly(ethylene sebacate) diol, and poly(butylene adipate) diol.

18. The composition of claim 15, wherein the composition comprises:
(i) polyester diol to chain extender ratio of 2.40:1 to 3.20:1;
(ii) a weight average molecular weight from 3260 kg/mol to 3480 kg/mol;
(iii) a polydispersity index of 1.03 to 1.04; and
(iv) a renewable carbon content of 51%.

19. The composition of claim 15, wherein the composition comprises:
(i) a hard segment block melting onset temperature of 81.7° C. to 110.3° C.;
(ii) a hard segment block peak melting temperature of 117.6° C. to 132.4° C.;
(iii) a hard segment block melting offset temperature of 122.9° C. to 142.9° C.; and
(iv) an enthalpy of melting of 17 J/g to 33 J/g.

20. The composition of claim 15, wherein the composition comprises:
(i) an initial modulus of 105±3 MPa to 201±9 MPa;
(ii) an ultimate tensile strength of 8.9±0.2 MPa to 26.5±0.6 MPa; and
(iii) an ultimate elongation at break of 11.6%±1.0% to 469%±1%.

21. The composition of claim 15, wherein the composition comprises:
(i) an onset temperature of thermal decomposition at 5% weight loss of 260.7° C. to 267.8° C.;
(ii) a peak decomposition temperature range of 307.0° C. to 456.8° C.; and
(iii) a percentage weight loss at decomposition of 18% to 75%.
